(19) United States
(12) Patent Application Publication
(10) Pub. No.: US 2026/0364509 A1
(43) Pub. Date: Nov. 19, 2026

(54) METHOD FOR OBTAINING A CH4-ENRICHED GAS FRACTION

(71) Applicant: Universiteit Twente, Enschede (NL)

(72) Inventors: Niels Mendel, Enschede (NL); Derk Willem Frederik Brilman, Enschede (NL); Igor Siretanu, Enschede (NL); Friederich Gunther Mugele, Enschede (NL)

(21) Appl. No.: 19/139,952

(22) PCT Filed: Dec. 22, 2023
(86) PCT No.: PCT/EP2023/087708

§ 371 Date: Jun. 17, 2025

(30) Foreign Application Priority Data
Dec. 22, 2022 (NL) 2033800

(51) Int. Cl. B01D 53/04; B01D 53/62; B01J 20/12; B01J 20/28

(52) U.S. Cl. CPC B01D 53/04; B01D 53/62; B01J 20/12; B01J 20/28004; B01J 20/2803; B01D 2253/11; B01D 2253/304; B01D 2256/245; B01D 2257/504

(57) ABSTRACT

The present invention relates to a method for obtaining a CH₄-enriched gas fraction from a gas mixture comprising CO₂ and CH₄, an aluminum phyllosilicate material for use in the same, and an adsorbent comprising the aluminum phyllosilicate material. The aluminum phyllosilicate material is characterized by the intercalating moieties and basal spacing, allowing the selectivity in adsorption.

### TECHNICAL FIELD

The present invention relates to a method of gas separation and purification using aluminum phyllosilicate adsorbents, in particular suitable for biogas upgrading.

### BACKGROUND OF THE INVENTION

Limiting global warming requires, in addition to reducing fossil fuel consumption, exploring sources of renewable energy. One source is gas produced via the anaerobic digestion of organic compounds (organic waste, manure, landfill waste, etc.), known as biogas. After being stripped of minor contaminants such as H₂S, H₂O, N₂, O₂, H₂, NH₃, CO, and/or siloxanes in a biogas cleaning or purification process, biogas contains mostly methane (CH₄, 50-70%) and carbon dioxide (CO₂, 30-50%). Although the cleaned biogas can be used directly for electricity and heat generation, the separation of both gases (known as biogas upgrading) increases the calorific value of the methane stream and can produce a high-purity CO₂ stream. The pure methane stream can then be used as a vehicle fuel, injected directly into the existing natural gas grid, or used to produce chemicals, while simultaneously preventing methane emissions to the atmosphere. The pure CO₂ stream can be utilized, for example, in greenhouses, for algae cultivation, or for synthetic fuel or chemical production, or sequestered. The recovery and, after upgrading, utilization of biogas can therefore play a significant role in the energy transition and the reduction of greenhouse gas emission.

There are several existing methods for biogas upgrading. The main methods include absorption (e.g., water-, chemical-, or organic scrubbing), membrane separation, and adsorption (most often pressure swing adsorption). These methods can be effective under appropriate circumstances, but often suffer from high investment- and/or operational cost (including chemicals), high energy consumption, and/or technological limitations.

Furthermore, in the adsorption method, the performance depends strongly on the adsorbent material used. The adsorption method is based on different adsorption affinities (equilibrium separation) or adsorption time scales (kinetic separation) between the to-be-separated species and the adsorbent. In short, this method requires a reactor column packed with the adsorbent material through which the gas mixture flows. The strongly or quickly adsorbed species (i.e., CO₂) are then retained in the column, whereas the weakly adsorbing species (i.e., CH₄) are collected in the effluent.

Ideal adsorbents should have a high (equilibrium or kinetic) CO₂/CH₄ selectivity for high CH₄ and CO₂ output purity and recovery, they should adsorb CO₂ quickly and be easy to regenerate, and they should have a high working capacity to limit the required amount of adsorbent and equipment size. In addition, they should be readily available, stable, and safe.

Typical adsorbents include zeolites and activated carbon, and carbon molecular sieves (CMS; kinetic-based separation). Adversely, these materials often suffer from a trade-off between high CO₂/CH₄ selectivity and easy regeneration. For example, Zeolite 13X, which has a high CO₂/CH₄ selectivity, also has a high isosteric heat of CO₂ adsorption (43-55 KJ mol-1) and steep CO₂ adsorption isotherms. It thus requires high energy input and a relatively high temperature and/or a low vacuum pressure for complete regeneration. On the other hand, materials that weakly bind CO₂, e.g., activated carbon, typically have low CO₂/CH₄ selectivity.

Furthermore, kinetic based adsorbents (may) demonstrate relatively slow CO₂ adsorption and desorption kinetics as compared to equilibrium-based sorbents.

It is thus imperative to find low-cost adsorption method with high CO₂/CH₄ selectivity that can rapidly adsorb and desorb CO₂. It is an object of the present invention provide such as method.

### SUMMARY OF THE INVENTION

The inventors have achieved the above object of the invention by discovering that cation-exchanged aluminum phyllosilicate clays with appropriately sized (optionally hydrated) cations and basal spacing may be used for separation of CO₂/CH₄ with high selectivity.

In the absence of adsorbed solvents, the interlayer spacing between adjacent layers in aluminum phyllosilicate clays is largely set by the size of the interlayer cations in the natural material (this state is typically referred-to as the “collapsed state”). However, via the exchange of these cations for others, the interlayer spacing is tuneable.

Without being bound by theory, the present inventors consider that the choice of appropriately sized (optionally hydrated) cations and basal spacing in the aluminum phyllosilicate clays allows to selectively adsorb CO₂ over CH₄.

It was already known that Cs⁺— or tetramethylammonium-exchanged montmorillonite provides an appropriate basal spacing for the sorption of carbon dioxide (Mendel et al. J. Phys. Chem. C 2021, 125, 49, 27159-27169). However, a use of such aluminum phyllosilicate clays in biogas upgrading was yet unknown.

The effectiveness of the adsorbent clays of the invention relates to the combination of high selectivity and fast adsorption and desorption kinetics of the adsorbents. This is achieved by providing an aluminum phyllosilicate material with one or more intercalating moieties selected from the group consisting of the alkali metal cations, the alkaline-earth metal cations, and (substituted) ammonium cations, to thereby preferably provide a basal spacing in the range of 10-15 Å.

The present inventors found particularly high selectivity in CO₂/CH₄ adsorption when the one or more intercalating moieties are selected from the group consisting of an Cs+, hydrated Mg²⁺, hydrated Ca²⁺, and a C₁-C₄ ammonium cation.

Under conditions relevant for biogas upgrading, collapsed aluminum phyllosilicate materials with small interlayer cations (e.g., Na⁺, Mg²⁺, and Ca²⁺, with a d-spacing d<10 Å) are typically not suitable for CO₂/CH₄ separation. However, the present inventors found that hydrated aluminum phyllosilicate material with the relatively smaller (and less costly, more readily available) interlayer cations Mg²⁺ and Ca² may be an alternative material for the relatively larger (and more costly, less readily available) such as Cs⁺ and/or ammonium cations in CO₂/CH₄ separation. Without being bound by theory, the present inventors believe that similar CO₂ and CH₄ adsorption isotherms can be achieved compared to e.g. Cs⁺ when these smaller cations are provided in a hydrated form in the aluminum phyllosilicate material. In a further aspect of the invention, a method is provided to achieve the appropriate hydration state for Mg²⁺ and Ca²⁺-exchanged aluminum phyllosilicate materials. The method preferably involves first hydrating the material (e.g. under appropriate humidity), subsequently followed by mild drying (e.g. at low temperature and/or nitrogen purge) to achieve the desired hydrated state of the aluminum phyllosilicate material.

The adsorbent clays of the invention show improved performance in CO₂/CH₄ separation compared to other known adsorbents. In particular, the inventors found surprisingly higher selectivity in CO₂/CH₄ adsorption compared to activated carbon and higher release of the captured CO₂ (e.g. faster and/or under milder condition) than Zeolite. It furthermore was found that adsorption on the aluminum phyllosilicate particles can be at least as fast as, and appears faster than adsorption on equally-sized carbon molecular sieve particles. The fast CO₂ adsorption and desorption kinetics allow for short cycle times and hence increased productivity. Overall, the method of the invention is particularly suitable under conditions relevant for biogas upgrading, that is, a (partial) pressure below 10 bar CO₂ and a temperature above 0 °C.

On the process side, aluminum phyllosilicate adsorbents of the invention are particularly suitable for (near-) ambient pressure conditions and desorption can be performed without the input of external heat, which (i) reduces the energy demand of the setup, and (ii) simplifies the setup and hence reduces capital and operational costs, compared to reactors that use higher pressures and/or external heating. Furthermore, the diffusional transport into the clay adsorbents of the invention is fast, which allows for the use of relatively large sorbent particles. The latter may allow a higher throughput or flow, which is particularly beneficial for application at an industrial scale.

In an aspect, the present invention relates to a method for obtaining a CH₄-enriched gas fraction from a gas mixture comprising CO₂ and CH₄, the method comprising contacting the gas mixture with an adsorbent and obtaining a CH₄-enriched gas fraction, wherein the adsorbent comprises an aluminum phyllosilicate material with one or more intercalating moieties selected from the group consisting of an alkali metal cation, an alkaline-earth metal cation, and an ammonium cation, to thereby preferably provide a basal spacing in the range of 10-15 Å.

The method is preferably applied in a reactor, allowing for good contacting between gas and sorbent, more preferably a fixed-bed type of contactor. Sorbent regeneration can be done by temperature swing, (partial) pressure swing or a combination thereof. Preferably, (partial- or system-) pressure swing methods are applied.

In an aspect, the present invention relates to an aluminum phyllosilicate material for obtaining a CH₄-enriched gas fraction from a gas mixture comprising CO₂ and CH₄, wherein the aluminum phyllosilicate material has one or more intercalating moieties selected from the group consisting of an alkali metal cation, an alkaline-earth metal cation, and an ammonium cation, to thereby preferably provide a basal spacing in the range of 10-15 Å, wherein the aluminum phyllosilicate material has a selectivity in CO₂/CH₄ adsorption of at least 2.

In an aspect, the present invention relates to a use of an aluminum phyllosilicate material as disclosed herein for obtaining a CH₄-enriched gas fraction from a gas mixture comprising CO₂ and CH₄.

The use is preferably in biogas and/or landfill gas upgrading.

In an aspect, the present invention relates to an adsorbent for obtaining a CH₄-enriched gas fraction from a gas mixture comprising CO₂ and CH₄, the adsorbent comprising the aluminum phyllosilicate material as disclosed herein.

In an aspect, the present invention relates to a device for obtaining a CH₄-enriched gas fraction from a gas mixture comprising CO₂ and CH₄, the device comprising the aluminum phyllosilicate material and/or the adsorbent as disclosed herein.

### DETAILED DESCRIPTION OF THE INVENTION

The method of the invention pertains to containing a gas mixture comprising carbon dioxide (i.e. CO₂) and methane (i.e. CH₄) with an adsorbent, thereby obtaining a CH₄-enriched gas fraction and/or a CO₂-enriched gas fraction.

In general, the method preferably involves:
providing a feed gas mixture (e.g. flue gas, biogas, landfill gas, natural gas) comprising carbon dioxide and methane; and/or
contacting the feed gas mixture with an adsorbent; and/or
allowing carbon dioxide from the feed gas mixture to adsorb onto the adsorbent, thereby
removing at least some of the carbon dioxide from the feed gas mixture to yield a methane-enriched gas stream, wherein the methane-enriched gas stream preferably has a lower concentration of carbon dioxide and a higher concentration of methane than the feed gas mixture.

The method may further comprise regenerating the adsorbent, thereby desorbing at least some of the carbon dioxide to obtain a carbon dioxide-enriched gas stream, wherein the carbon dioxide-enriched gas fraction preferably has a higher concentration of carbon dioxide and/or a lower methane concentration than the feed gas mixture and/or the methane-enriched gas stream.

In an embodiment, the method of the invention involves adsorbing CO₂ from the gas mixture (i.e. the first gas stream) on the adsorbent, wherein selective adsorption of CO₂ over CH₄ may provide the CH₄-enriched gas. The gas mixture may be contacted with the adsorbent as a flow, such as generated by a blower or a compressor. The gas mixture may be heated or cooled in order to obtain the appropriate temperature. The gas mixture may include water. At least some of the water can be removed from the gas mixture before contacting with the adsorbent.

The adsorbent may be packed in any suitable column, vessel, or alike (e.g. steel such as stainless steel, plastic, concrete etc.), and the method may involve passing the gas mixture through the column.

In an embodiment, the gas (e.g. gas mixture, CO₂-enriched gas and/or CH₄-enriched gas) comprises at least 5%, or 10%, or 20%, or 30%, or 40%, or 50%, or 60%, or 70%, or 80%, or 90%, or 95% CO₂ and/or CH₄, calculated on the gas. In an embodiment, the gas comprises no more than 95%, or 90%, or 85%, or 80%, or 75%, or 70%, or 65%, or 60%, or 55%, or 50%, or 45%, or 40%, or 35%, or 30%, or 25%, or 20%, or 15%, or 10%, or 5% CO₂ and/or CH₄, calculated on the gas mixture.

In a preferred embodiment, the gas mixture comprises 10-60% CO₂ and/or 35-85% CH₄, preferably 20-50% CO₂ and/or 45-75% CH₄, more preferably 30-40% CO₂ and/or 55-65% CH₄, calculated on the gas mixture.

In a preferred embodiment, the CH₄-enriched gas comprises 0-40% CO₂ and/or 60-100% CH₄, preferably 1-30% CO₂ and/or 70-95% CH₄, more preferably 5-20% CO₂ and/or 80-90% CH₄, calculated on the gas mixture.

In a preferred embodiment, the CO₂-enriched comprises 0-40% CH₄ and/or 60-100% CO₂, preferably 1-30% CH₄ and/or 70-95% CO₂, more preferably 5-20% CH₄ and/or 80-90% CO₂, calculated on the gas mixture.

As used herein, the percentage (%) of a gas is expressed as the volume % (vol. %).

The present inventors found that the method of the invention is particularly suitable to be performed at (near-) ambient pressure and/or temperature. This may reduce the energy demand of the setup and may simplify the setup, and hence reduces capital and operational costs. In an embodiment, the adsorption pressure during the adsorbing step is at a CH₄ and/or CO₂ partial pressure of 0.01-100 bar, preferably 0.05-20 bar, more preferably 0.1-10 bar, even more preferably 0.5-5 bar (e.g. 0.7-3 bar or 1-2 bar). In an embodiment, the adsorption temperature during the adsorption step is at a temperature (of the gas) of −20 °C-100 °C, preferably-10-90 °C, more preferably 0-70 °C, even more preferably 10 °C-50 °C. The gas separation is preferably according to a pressure swing adsorption method.

In an embodiment, the method of the invention involves a step of regenerating the adsorbent.

The regeneration of the adsorbent preferably desorbs the carbon dioxide. The prevent inventors found that the desorption surprisingly can be performed without the input of external heat, which is therefore a preferred embodiment of the invention.

The “regenerating” step may involve one or more a temperature-swing, a pressure-swing, a concentration-swing, a humidity swing, or a combination thereof. The “regenerating” step preferably uses a lower pressure that in the adsorbing step. In an embodiment, the “regenerating” step involves subjecting the adsorbent to a vacuum, e.g. thereby allowing to obtain a CO₂-enriched gas fraction with (essentially) pure CO₂ (e.g. more than 90%, or 95%, or 99%, or 100% CO₂).

The aluminum phyllosilicate material of the invention pertains to a material for obtaining a CH₄-enriched gas fraction.

The adsorbent preferably comprises an aluminum phyllosilicate material with one or more intercalating moieties selected from the group consisting of an alkali metal cation, an alkaline-earth metal cation, and a (substituted) ammonium cation, to thereby preferably provide a basal spacing in the range of 10-15 Å.

The term “aluminum phyllosilicate” as used herein means any (clay) mineral comprising Si, Al, and O and typically with additional metal cations, characterized by Al in octahedral coordination with O(H) that are bound to one (1:1) or two (2:1) sheets of Si in tetrahedral coordination with O, e.g. forming parallel aluminosilicate sheets. In addition or alternatively, the term “aluminum phyllosilicate” as used herein can mean any (clay) mineral composed on parallel aluminosilicate sheets. The “aluminum phyllosilicate” according to the invention are also typically referred to as “layer aluminosilicate” or “layered aluminosilicate” and therefore encompassed in the term. The “aluminum phyllosilicate” material in the context of the current invention is preferably cation-exchanged, meaning that one or more cations in the aluminum phyllosilicate is interchanged, preferably one or more interlayer cations and/or cations on any negatively charged particle (e.g. clay mineral). The term “aluminum phyllosilicate material” encompasses natural materials and materials that are not found as such in nature, for example when subjected to cation-exchange with one or more (intercalating) moieties not naturally found in the material. Aluminum phyllosilicate materials encompass materials subjected to a “doping” or “loading” step with the aim of introducing (controlled amounts) of intercalating moieties such as intercalating cations. The aluminum phyllosilicate material in the context of the current invention thus also includes “doped aluminum phyllosilicate” and/or “loaded aluminum phyllosilicate”. The aluminum phyllosilicate material in the context of the current invention encompasses a clay subjected to exfoliation, thus being exfoliated, meaning that the layers are spatially separated by a delamination process and preferably leading to increased basal spacing. The term “aluminum phyllosilicate” preferably excludes non-layered aluminosilicates such as zeolite. The “aluminum phyllosilicate” material in the context of the current invention in addition or alternatively encompasses “activated” material, meaning any many treated physically and/or chemically to adsorb (e.g. stronger and/or with higher selectivity). The various aluminum phyllosilicate materials are known to the skilled person, e.g. from the “Handbook of clay science” (1st Edition—May 9, 2006, Editors: Faïza Bergaya, B. K. G. Theng, G. Lagaly), and these aluminum phyllosilicate materials are suitable in the context of the current invention. The term “aluminum phyllosilicate” encompasses materials synthesized in a reactor.

Preferably, the aluminum phyllosilicate is (derived from) a clay material provided from a natural source such as from a mine. This for instance allows the material to be provided in sufficient quantities and at desirable low cost. Preferably, the aluminum phyllosilicate is found and/or comprised in a naturally occurring material such as bentonite and/or Fuller's earth. The clay material from a natural source may or may not have been activated already, or processed otherwise, prior to subjecting to an exchange a to achieve the aluminum phyllosilicate material according to the invention. For example, the clay material from a natural source encompasses commercially-available clays derived from a natural source which are for instance activated with an alkaline-earth metal cation and/or alkali metal cation [e.g. Na-activated montmorillonite-rich bentonite clay or Wyoming MMT (SWy-3)], prior to (further) cation exchange according to the invention.

In an embodiment, the aluminum phyllosilicate is a smectite-containing and/or a vermiculite-containing material. The aluminum phyllosilicate, preferably the smectite-containing and/or the vermiculite-containing material as disclosed herein, may comprise one or more selected from the group consisting of montmorillonite, beidellite, nontronite, volkonskoite, saponite, sauconite, and hectorite, preferably montmorillonite. In addition or alternatively, the smectite as disclosed herein can be one or more selected from the group consisting of montmorillonite, beidellite, nontronite, volkonskoite, saponite, sauconite, and hectorite, preferably montmorillonite. The term “smectite” as used herein preferably means a clay mineral with a 2:1 layer silicate structure and having 2 tetrahedral sheets surrounding a central octahedral sheet that can expand and contract upon wetting and drying, e.g. which can include illite/mica, chlorite, and vermiculite groups.

In a preferred embodiment, the aluminum phyllosilicate material as disclosed herein is a smectite- and/or vermiculite-containing material. In a preferred embodiment, the smectite-containing material is bentonite. In a preferred embodiment, the smectite-containing material is Fuller's earth. In a preferred embodiment, the vermiculite-containing material is bentonite. In a preferred embodiment, the vermiculite-containing material is Fuller's earth. In a preferred embodiment, the smectite is montmorillonite and/or comprises montmorillonite.

The term “intercalated moiety” as used herein means any moiety (e.g. cation or hydrated cation) inserted in between the aluminosilicate sheets and/or inserted to interact electrostatically with one or more negatively charged basal planes of the aluminosilicate sheets.

The “cation” in the context of the current invention encompasses hydrated cations (i.e. a cation surrounding by a hydration shell and/or with water molecules arranged around it), most preferably a hydrated metal cation, more preferably a hydrated alkaline-earth metal cation, most preferably hydrated calcium cation (Ca²⁺) or hydrated magnesium (Mg²⁺) cation. The number of water molecules associating with a cation in a hydrated state can vary. Magnesium or calcium ions typically form complexes with approximately six water molecules, but this can be fewer or more (e.g. 2, 3, 4, 5, 6, 7, 8, 9, 10 water molecules) depending on the specific conditions. For example, hydrated calcium (Ca²⁺) can be represented as Ca(H₂O)₆²⁺, indicating that calcium is coordinated with six water molecules in its hydrated state, and hydrated magnesium (Mg²⁺) can be represented as Mg(H₂O)₆²⁺ to indicate a magnesium ion coordinated with six water molecules.

Under conditions relevant for biogas upgrading, collapsed aluminum phyllosilicate materials with small interlayer cations (e.g., Na⁺, Mg²⁺, and Ca²⁺, with a d-spacing d<10 Å) are typically not suitable for CO₂/CH₄ separation. However, the present inventors found that hydrated aluminum phyllosilicate material with the relatively smaller (and less costly, more readily available) interlayer cations Mg²⁺ and Ca² may be an alternative material for the relatively larger (and more costly, less readily available) such Cs⁺ and/or ammonium cations in CO₂/CH₄ separation. Without being bound by theory, the present inventors consider that similar CO₂ and CH₄ adsorption isotherms can be achieved compared to e.g. Cs⁺ when these smaller cations are provided in a hydrated form in the aluminum phyllosilicate material. In a further aspect of the invention, a method is provided to achieve the appropriate hydration state for Mg²⁺ and Ca²⁺-exchanged aluminum phyllosilicate materials. The method preferably involves first hydrating the material (e.g. under appropriate humidity), subsequently followed by mild drying (e.g. at low temperature and/or nitrogen purge) to achieve desired hydrated state of the aluminum phyllosilicate material.

In a preferred embodiment, the cation is a hydrated cation.

In a preferred embodiment, the alkaline-earth metal cation is hydrated calcium (Ca²⁺) cation, e.g. one or more of Ca(H₂O)₁²⁺, Ca(H₂O)₂²⁺, Ca(H₂O)₃²⁺, Ca(H₂O)₄²⁺, Ca(H₂O)₅²⁺, Ca(H₂O)₆²⁺, Ca(H₂O)₇²⁺, Ca(H₂O)₈²⁺, Ca(H₂O)₉²⁺ or Ca(H₂O)₁₀²⁺.

In a preferred embodiment, the alkaline-earth metal cation is hydrated magnesium (Mg²⁺) cation, e.g. one or more of Mg(H₂O)₁²⁺, Mg(H₂O)₂²⁺, Mg(H₂O)₃²⁺, Mg(H₂O)₄²⁺, Mg(H₂O)₅²⁺, Mg(H₂O)₆²⁺, Mg(H₂O)₇²⁺, Mg(H₂O)₈²⁺, Mg(H₂O)₉²⁺ or Mg(H₂O)₁₀²⁺.

There are several techniques suitable in the context of the current invention to determine whether cations (e.g. Mg, Ca) in between the aluminosilicate sheets are hydrated or not, such as X-ray diffraction, infrared spectroscopy, thermogravimetric analysis, nuclear magnetic resonance. A method known to the skilled person and preferred in the context of the current invention is infrared spectroscopy (Yeşilbaş et al. ACS Earth Space Chem. 2018, 2, 1, 38-47; Wu et al. Clays and Clay Minerals 2000; 48 (1): 120-131).

In certain embodiments, the cation as disclosed herein is preferably not a hydroxylated cation. The term “hydroxylated cation” in the context of the current invention means the addition of hydroxide ions (OH⁻) to the cation, forming a hydroxide complex. This typically occurs in alkaline solutions where hydroxide ions are abundant.

For example, hydroxylated calcium (Ca²⁺) can be represented as Ca(OH)₂ to indicate addition of two hydroxide ions to form a calcium hydroxide compound, and hydroxylated magnesium (Mg²⁺) can be represented as Mg(OH)₂ to indicate addition of two hydroxide ions to form a magnesium hydroxide compound.

The present inventors have studied the competitive and synergistic adsorption of H₂O and CO₂. It was found that in general, for optimal CO₂ adsorption, the interlayer space comprises cations that are hydrated, preferably hydrated calcium and/or hydrated magnesium, but the remainder of the interlayer space is low or free in water molecules. In such a scenario, the hydration may occur selectively around certain cation sites that promote hydration in said specific locations, whereas the amount of free water is low or absent. A method known to the skilled person and preferred in the context of the current invention to determine if water is present in the interlayer space and/or associated cations (i.e. as hydrated cations) is by infrared spectroscopy (Yeşilbaş et al. ACS Earth Space Chem. 2018, 2, 1, 38-47; Wu et al. Clays and Clay Minerals 2000; 48 (1): 120-131). In addition or alternatively, water in the interlayer space can be detected for example by
a d-spacing as measured using X-Ray diffraction analysis (XRD) that is greater than ~10-10.5 A,
a mass loss using Thermogravimetric analysis (TGA) up until 250-300 °C (1-10 °C/min) that is greater than 0.5% of the dry sample mass, possibly further verified using Fourier transform infrared (FTIR) analysis of the released water,
presence of features in the Attenuated total reflection-Infrared (ATR-IR) spectrum around 1632 cm⁻¹ corresponding to the H—O—H bending mode.

The present inventors surprisingly found that for Mg and Ca exchanged the desired hydration state can be achieved by:
a) a first step of hydrating the aluminum phyllosilicate material; and
b) a second step of drying the aluminum phyllosilicate material hydrated in step a).

It is preferred that the water adsorption as a result of step a) is more than 5 mmol/g. In the case of Mg or Ca exchanged clays, this is achieved by subjecting to approximately 40% RH (e.g. 30-50% RH) It is even more preferred that the water adsorption as a result of step a) is more than 10 mmol/g. In the case of Mg or Ca exchanged clays, this is achieved by subjecting to approximately 80% RH (e.g. 70-90% RH).

Preferably, step a) involves subjecting the aluminum phyllosilicate material to increased humidity (e.g. relative humidity RH), such as 40-99% RH, 50-95% RH, 60-90% RH, preferably 70-90% RH, which can also be referred to as a “pre-humidifying” step. The hydration or pre-humidifying step is preferably performed for at least 6 hours, or at least 12 hours, or at least 18 hours, or at least 24 hours, such as 6-48 h, preferably 12-24 h. The aluminum phyllosilicate material is preferably hydrated in step a) to an amount of to an amount 1-50 mmol H₂O, preferably 2-20 mmol H₂O, more preferably 3-15 mmol H₂O, even more preferably 5-10 mmol H₂O, all per g aluminum phyllosilicate material. The aluminum phyllosilicate material in step a) preferably comprises (hydrated) Mg²⁺ and/or Ca²⁺ as interlayer cation.

In embodiments, step a) as hydration step involves subjecting the aluminum phyllosilicate material to a liquid, preferably aqueous liquid, more preferably liquid water.

The preferential remaining amount of water as a result of step b) is 1-10 water molecules, preferably 2-5 water molecules per interlayer cation (e.g. Mg(H₂O)₅²⁺ or Ca(H₂O)₅²⁺ indicating 5 water molecules per interlayer cation). The remaining water after drying is preferably expressed as the number of water molecules per interlayer cation, as it may considers the fact that the number of cations in the structure may vary per clay base material.

Preferably, step b) involves, low temperature drying, for example at a temperatures below 150 °C, preferably below 100 °C, more preferably below 70 °C, e.g. 20-60, or 25-50 °C. In a preferred embodiment, step b) involves low temperature drying at (near-) ambient temperature. In addition or alternatively, step b) preferably involves dry purging to remove moisture from the interlayer space, wherein the purging may be performed with dry air, nitrogen, argon, helium or combinations thereof. Preferably the purging is performed with dry nitrogen (N₂). The drying in step b) is preferably performed for at least 12 hours, or at least 48 hours, or at least 72 hours, such as 12-72 hours, preferably 24-48 hours. The aluminum phyllosilicate material is preferably dried in step b) to obtain on average 0.5-20 H₂O molecules per interlayer cation, preferably on average 1-10 H₂O molecules per interlayer cation, even more preferably on average 2-5 H₂O molecules per cation, wherein the interlayer cation is preferably (hydrated) Mg²⁺ and/or Ca²⁺.

The present inventors found that mild drying conditions help achieve the desired hydrated state of the aluminum phyllosilicate material, without removing too much water.

The alkali metal cation as disclosed herein may be one or more selected from the group consisting of Lit, Na⁺, K⁺, Rb⁺, Cs⁺, and Fr⁺ cation.

In a preferred embodiment, the alkali metal cation is Cs⁺ (i.e. caesium, cesium) cation.

In a preferred embodiment, the alkali metal cation is K⁺ cation.

The alkaline-earth metal cation as disclosed herein may be one or more selected from the group consisting of Be2+, Mg²⁺, Ca²⁺, Sr²⁺, Ba²⁺, and Ra²⁺ cation.

In a preferred embodiment, the alkaline-earth metal cation is Mg²⁺ cation.

In a preferred embodiment, the alkaline-earth metal cation is Ca²⁺ cation.

The “ammonium cation” in the context of the current invention encompasses substituted ammonium cation, meaning ammonium cation wherein one or more hydrogen atoms are substituted with another organic group, such as an C1-C4 alkyl, most preferably a methyl group.

In an embodiment, the ammonium cation is alkyl ammonium cation and/or C1-C4 alkyl ammonium cation. In an embodiment, the alkyl ammonium cation and/or C1-C4 alkyl ammonium cation is methylammonium, dimethylammonium, trimethylammonium, or tetramethylammonium cation, preferably methylammonium cation and/or tetramethylammonium cation.

In a preferred embodiment, the ammonium cation is methylammonium cation.

In a preferred embodiment, the ammonium cation is tetramethylammonium cation.

The present inventors found that it was particularly beneficial if the cation disclosed herein has an ionic radius in appropriate range. In an embodiment, the cation as disclosed herein has an ionic radius of 150-350 μm, or 160-330 μm, or 170-320 μm.

The present inventors found that an appropriate amount of the intercalating cations is beneficial in terms of the materials' conformation (e.g. basal spacing) and/or sorption properties, in particular when the adsorbent comprises smectite, most preferably montmorillonite, as aluminum phyllosilicate material.

In a preferred embodiment, the (amount of the one or more of intercalating moieties in the aluminosilicate material is 0.1-3 mEq, preferably 0.2-2 mEq, more preferably 0.4-1.2 mEq, most preferably 0.6-1.0 mEq, all per g aluminum phyllosilicate material, wherein the weight (g) is preferably the dry weight.

In an embodiment, the amount of cation in the aluminosilicate material is 0.1-3 mEq, preferably 0.2-2 mEq, more preferably 0.4-1.2 mEq, most preferably 0.6-1.0 mEq, all per g aluminum phyllosilicate material, wherein the weight (g) is preferably the dry weight, wherein the cation is Cs⁺, K⁺, Ca²⁺, Mg²⁺, hydrated Ca²⁺, hydrated Mg²⁺, methylammonium, or tetramethylammonium cation.

The amount of the one or more of intercalating moieties in the aluminum phyllosilicate material may be at least 0.01, 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 5.9, 6.0, 6.5, 7.0, 7.5, 8.0, 8.5, 9.0, 10, 11, 12, 13, 14, or 15 mEq per g aluminum phyllosilicate material, wherein the weight (g) is preferably the dry weight. In addition or alternatively, the amount of the one or more of intercalating moieties in the aluminum phyllosilicate material may be no more than 15, 14, 13, 12, 11, 10, 9, 8.5, 8.0, 7.5, 7.0, 6.5, 6.0, 5.9, 5.8, 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, 0.1, or 0.05 mEq per g aluminum phyllosilicate material, wherein the weight (g) is preferably the dry weight.

In the context of the current invention, the amount of the one or more intercalating moieties in the aluminum phyllosilicate material can be determined by any suitable analytical technique for the elemental analysis or chemical characterization of a sample known to the skilled person. In a preferred method, Energy-Dispersive X-ray spectroscopy (also known as EDX, EDXA, or EDS) provides a wt. % of a certain atom type, from which the milliequivalents (mEq) value can be derived. In an example, for a Cs-activated clay, only one EDX measurement can be sufficient, and reflects the amount of intercalated Cs cations. In addition or alternatively, the amount of the intercalating moieties in the aluminum phyllosilicate material can be determined from the difference in the chemical composition of the material before and after exchange. In an example, an increase in Cs mass in the material after exchange with Cs may correspond to the number of Cs intercalating moieties, whereas changes in mass percentage moieties other than Cs can similarly be derived from the chemical characterization of the material before and after Cs exchange.

In an embodiment, the aluminum phyllosilicate and/or adsorbent as disclosed herein is “anhydrous”. The term “anhydrous” as used herein to describe a material means that there is (essentially) no free interlayer water. In addition or alternatively, a material is herein considered to be “anhydrous” when it has a (free and/or non-adsorbed) water no more than the content it would have if 10 g of the material is dried at 60 °C under dry nitrogen for at least 24 h. In addition or alternatively, an “anhydrous material” can mean a material with less than 5 wt. %, or less than 1 wt. %, or less than 0.1 wt. %, or less than 0.01 wt. %, or less than 0.001 wt. %, or less than 0.0001 wt. % (free and/or non-adsorbed) water, calculated per weight of the material.

The present inventors found that for certain cations, particularly certain alkaline-earth metal cations such as Ca²⁺ and/or Mg²⁺, the selective CO₂/CH₄ adsorption is especially high when the aluminum phyllosilicate comprises a threshold amount of water, for instance a water content in the range of 0.5-5 wt. %. Without being bound by theory, the threshold amount of water may facilitate the basal spacing and/or the hydration of cations in the context of the current invention.

In an embodiment, the aluminum phyllosilicate and/or adsorbent as disclosed herein comprises water, allowing to open up the interlayer space. In an embodiment, the aluminum phyllosilicate and/or adsorbent comprises 0.1-15 wt. %, preferably 0.2-10 wt. %, more preferably 0.5-5 wt. %, even more preferably 1-3 wt. % water, wherein the water is preferably adsorbed and/or associated with one or more hydrated cations.

The present inventors found that the aluminum phyllosilicate material has a surprisingly high selectivity in CO₂/CH₄ adsorption, which is particularly seen for a basal spacing of the aluminum phyllosilicate material in the range of 10-15 Å.

In a preferred embodiment, the aluminum phyllosilicate material has a basal spacing in the range of 9-16 Å (angstroms), preferably 10-15 Å, more preferably 10.5-14.5 Å, even more preferably 11-14 Å, most preferably 11.5-13. Å.

The term “basal spacing” as used in the context of the current invention means the distance between two layers (i.e. the interlayer distance) plus thickness of a single layer.

The basal spacing can be measured by x-ray reflectivity. For instance, the (001) reflection under (powder) X-ray diffraction can be measured, from which the Basal spacing can be calculated using Braggs Law, known to the skilled person. The material can be optionally first hydrated (e.g. in 90% RH nitrogen) and then equilibrated (e.g. in 10% RH nitrogen).

In the context of the current invention, the basal spacing is preferably measured under 1 or 10 bar CO₂ and at 20 °C.

In a preferred embodiment, the aluminum phyllosilicate material has a selectivity in CO₂/CH₄ adsorption of at least 2, preferably at least 5, more preferably at least 10, even more preferably at least 20, for example 2-40, or 3-30, or 2-20, or 5-10. The selectivity in CO₂/CH₄ adsorption in the context of the invention is preferably defined as the ratio in CO₂/CH₄ adsorption capacity measured at a total pressure of 1 bar and at 20 °C for a 50/50% CO₂/CH₄ gas mixture.

In a preferred embodiment, the aluminum phyllosilicate material has a CO₂ adsorption capacity of at least 0.4 mmol g⁻¹, preferably at least 0.8 mmol g⁻¹, even more preferably at least 1.0 mmol g⁻¹, most preferably at least 1.5 mmol g⁻¹, such as for example 0.4-4.0 mmol g⁻¹, or 0.8-3.0 mmol g⁻¹, or 1.0-2.0 mmol g⁻¹. The CO₂ adsorption capacity is preferably measured at a pressure of 10 bar and at 20 °C for pure CO₂.

In an embodiment, the aluminum phyllosilicate material and a CH₄ adsorption capacity of no more than 0.05 mmol g⁻¹, preferably of no more than 0.1 mmol g⁻¹, even more preferably of no more than 1 mmol g⁻¹, most preferably of no more than 2 mmol g⁻¹. The CH₄ adsorption capacity is preferably measured at a pressure of 10 bar and at 20 °C for pure CH₄.

The adsorption capacity in the context of the present invention can be measured according to the Sievert's technique which is common to the skilled person. The Example illustrates a preferred protocol to determine the adsorption capacity with a Sieverts apparatus. In determining the adsorption capacity, adsorbed quantity of CO₂ or CH₄ can be calculated using the Van der Waals equation (e.g. to account for non-ideality of the gases). In addition or alternatively, the adsorption capacity can be measured by any gravimetric analysis method suitable in the art.

The present inventors found that the adsorbent composition, in particular the inclusion of a clay binder and/or particle size may influence the CO₂ and/or CH₄ sorption capacity.

The adsorbent as disclosed herein may comprise one or more binder materials (i.e. “binder”), meaning any material that is added primarily for agglomerating or compacting individual elements in the adsorbent. In addition or alternatively, the binder in the context of the current invention may enhance the mechanical properties (e.g. higher strength) or stability of the adsorbent. In addition or alternatively, the one or more binders may improve the plasticity of the adsorbent for shaping into a body (i.e. the binder then being a plasticizing binder). In addition or alternatively, the binder may increase the overall porosity of the adsorbent. The binder as disclosed herein may be a clay binder, preferably an aluminum phyllosilicate, preferably a non-cation-exchanged or non-activated aluminum phyllosilicate and/or an aluminum phyllosilicate from a natural source activated in another way (e.g. when commercially available) than according to the present invention. For example, the adsorbent of the invention may comprise activated aluminum phyllosilicate (e.g. activated bentonite, smectite, vermiculite and/or montmorillonite) and a further non-activated aluminum phyllosilicate (e.g. non-activated bentonite, smectite, vermiculite and/or montmorillonite) and/or an aluminum phyllosilicate from a natural source activated in another way (e.g. when commercially available) than according to the present invention, wherein the non-activated aluminum phyllosilicate in the adsorbent may be the same or a different material than the activated aluminum phyllosilicate material in the adsorbent. The binder as disclosed herein may be any known (plasticizing) organic binder, such as cellulose ether type binders and/or their derivatives some of which are thermally gellable. Typical organic binders that may be suitable in the context of the current invention may be one or more selected from the group consisting of methylcellulose, ethylhydroxy ethylcellulose, hydroxybutylcellulose, hydroxybutyl methylcellulose, hydroxyethylcellulose, hydroxymethylcellulose, hydroxypropylcellulose, hydroxypropyl methylcellulose, hydroxyethyl methylcellulose, and sodium carboxy methylcellulose, and mixtures thereof.

The present inventors found that hydrated Mg- and Ca-exchanged aluminum phyllosilicates can undergo significant swelling due to for example water adsorption and desorption, in comparison to e.g. Cs- or TMA-exchanged aluminum phyllosilicates. Hence, it is preferred to select binders that can accommodate the amount of swelling and expansion of the aluminum phyllosilicates layers, without affecting the binder structural integrity (e.g. caused by crack formation after swelling).

In certain embodiments, preferably for hydrated Mg- and Ca-exchanged aluminum phyllosilicates, a binder is which is flexible enough and able to withstand the expansion and contraction of the aluminum phyllosilicates layers. Binders with such properties and suitable for the invention are rubber-based or polymer-based binders.

In a preferred embodiment, the binder is a rubber-based binder, for example comprising one or more selected from the group consisting of styrene-butadiene rubber, chloroprene rubber (Neoprene), latex and natural rubber. In a preferred embodiment, the binder comprises 1-15%, preferably 2-10% rubber, preferably a rubber as disclosed herein.

In a preferred embodiment, the binder is a polymer-based binder, for example comprising one or more selected from the group consisting of polyurethane, polyethylene oxide, polyacrylamide, polyvinyl alcohol, carboxymethyl cellulose, hydroxyethyl cellulose and polyethylene glycol.

In a preferred embodiment, the binder comprises a solvent. In an embodiment, the solvent is a polar or non-polar solvent. In an embodiment, the solvent is an inorganic or organic solvent. In an embodiment, the adsorbent comprises 0.5-60 wt. % of the binder material and 40-99.5 wt. % of the aluminum phyllosilicate material, for instance 1-40 wt. % of the binder material and 60-99 wt. % of the aluminum phyllosilicate material, or 5-30 wt. % of the binder material and 70-95 wt. % of the aluminum phyllosilicate material, or 10-20 wt. % of the binder material and 80-90 wt. % of the aluminum phyllosilicate material, all calculated on the weight of the binder material and the aluminum phyllosilicate material, wherein the weight is preferably the dry weight.

The adsorbent as disclosed herein may be in one or more forms selected from the group consisting of a powder, a film, a fiber, a coating, a self-supporting structure, a monolith, and particles (e.g. granules, beads, pellets), with or without binder.

When the binder is in the form of particles, the particles preferably have an average diameter of 0.1-50 mm, more preferably 0.5-20 mm, even more preferably 1.0-10 mm, most preferably 1.5-5.5 mm.

The “gas mixture” as disclosed can be any mixture of gases comprising CO₂/CH₄. In a preferred embodiment, the gas mixture is biogas, meaning a gas produced from raw materials such as one or more of agricultural waste, manure, municipal waste, plant material, sewage, green waste and food waste. In addition or alternatively, biogas can mean any gas produced by anaerobic digestion with anaerobic organisms or methanogen inside an anaerobic digester, biodigester or a bioreactor. Biogas typically is a saturated gas mixture mainly of methane, carbon dioxide, and furthermore may contain hydrogen sulfide and/or siloxanes. In a preferred embodiment, the gas mixture landfill gas, meaning a type of biogas that originates from the decomposition of organic waste in a landfill. The use as disclosed herein encompasses the “upgrading” of the gas mixture, meaning that the gas is enriched in methane and carbon dioxide is (sufficiently) removed to for instance obtain bio-methane.

One aspect of the invention may relate to a method for preparing the aluminum phyllosilicate material.

In an embodiment, the method for preparing the aluminum phyllosilicate material involves a step of cation exchange, preferably by contacting the aluminum phyllosilicate with a solution comprising a salt of the desired cation, more preferably a fluoride, a bromide, a chloride, an iodide, a nitrate, a sulfate, a phosphate, a hydroxide or a carbonate may be used. In an embodiment, the cation-exchange is performed at alkaline pH, e.g. pH 7-12, or 8-11, or 9-10, and the pH of the solution may be adjusted accordingly by adding a pH-adjusting compound. In an embodiment, the cation-exchange is performed at acidic pH, e.g. pH 2-7, or 3-6, or 4-5, and the pH of the solution may be adjusted accordingly by adding a pH-adjusting compound. For cation-exchange a batch method or column flow method can be employed, wherein the batch method may be more suitable for uniform cation-exchanging. The cation-exchange can be performed at any temperature, including at room temperature. The present inventors found under certain conditions the cation-exchange is improved at elevated temperature such as 50-70 °C. The temperature during cation-exchanging may be also from 30-100 °C, or 40-80 °C, or 50-70 °C. In an embodiment, the salt or cation is present in the solution in an amount of 0.01-50 mmol per gram aluminum phyllosilicate, preferably 0.05-25 mmol per gram aluminum phyllosilicate, more preferably 0.1-20 mmol per gram aluminum phyllosilicate, even more preferably 0.5-10 mmol per gram aluminum phyllosilicate. If two or types of cations are introduced into the aluminum phyllosilicate material, the aluminum phyllosilicate may be brought into contact with the different types of cations simultaneously, separately and/or successively to allow cation exchange. For instance, the aluminum phyllosilicate may be immersed in a first solution comprising a first type of cation, before being immersed in a second and possibly further solution comprising a further type of cation. After each ion exchange procedure the aluminum phyllosilicate can be suitably washed and dried.

In an embodiment, the aluminum phyllosilicate can be provided in a dialysis membrane to remove solutes and/or to equilibrate the solution in a new buffer.

In an embodiment, the concentration of one or more cations in the solution can be in a concentration of 0.5-20 times, preferably 1-15 times, more preferably 2-10 times, even more preferably 3-6 times, the cation exchange capacity (CEC, in mEq/g) of the aluminum phyllosilicate. An example is provided for Cs-exchanged montmorillonite: considering a CEC of montmorillonite of 0.8 mEq/g, one may mix 1 gram of montmorillonite with 1 mmol of Cs(Cl) (~168 mg), and any desirable amount of water (e.g. 10 ml of water per gram clay). The skilled person knows the CEC of aluminum phyllosilicates. For example, the cation exchange capacity of montmorillonite is described in the “Data Handbook for Clay Materials and Other Non-Metallic Minerals (Van Olphen, H. and Fripiat, J. J., 1979, Pergamon Press, Oxford).

In an embodiment, the aluminum phyllosilicate can be provided in the solution for a time chosen as to achieve the desired cation-exchange and/or for at least 24 h, preferably at least 7 days, more preferably at least 14 days, more preferably at least 21 days, even more preferably at least 28 days, such as 1-10 weeks, or 2-8 weeks, or 4-6 weeks.

In an embodiment, the method for preparing the aluminum phyllosilicate material can involve a step of washing after the cation exchange.

In an embodiment, the method for preparing the aluminum phyllosilicate material involves a step of removing (excess) salt during and/or after cation exchange. In an embodiment, the removal of (excess) salt involves providing the aluminum phyllosilicate, preferably in a dialysis membrane, in water such as distilled water or ultra-pure water.

The cation exchange may be performed before or after adding an optional binder material as disclosed herein.

In an embodiment, the method for preparing the aluminum phyllosilicate material involves a step of drying the aluminum phyllosilicate material after cation-exchange and/or salt-removal. The drying may be performed at for example 40-100 °C, or 50-80 °C, or 55-80 °C. The drying may be performed as long needed to achieve the amount of (free) water, or the absence thereof, in the aluminum phyllosilicate. In an embodiment, the drying is performed as to achieve an anhydrous aluminum phyllosilicate as disclosed herein.

One aspect of the invention may relate to a method for preparing the adsorbent. In an embodiment, the adsorbent consists of the cation-exchanged aluminum phyllosilicate. In an embodiment, the adsorbent comprises the cation-exchanged aluminum phyllosilicate without a further binder. In an embodiment, the adsorbent comprises the cation-exchanged aluminum phyllosilicate with a binder.

In an embodiment, the adsorbent is prepared by combining the cation-exchanged aluminum phyllosilicate with a binder in necessary amounts (e.g. mass ratios), as to achieve the adsorbent of the invention. For example, the cation-exchanged aluminum phyllosilicate may be combined with as-received and/or non cation-exchanged aluminum phyllosilicate serving as binder in a mass ratio of 1:0.01-1:2, or 1:0.05-1:1, or 1:0.5-1:0.1. The method for preparing the adsorbent may optionally comprise adding a solvent (e.g. water or other aqueous medium) to the aluminum phyllosilicate and binder, followed by mixing the components (e.g. by kneading or agglomerating). The preparation of the binder may involve a step of drying the adsorbent after combing the cation-exchanged aluminum phyllosilicate and the binder, for example at 40-100 °C, or 50-80 °C, or 55-80 °C. The drying of the adsorbent may be performed as long needed to achieve the amount of (free) water, or the absence thereof, in the adsorbent. In an embodiment, the drying is performed as to achieve an anhydrous adsorbent.

The use of the invention pertains to a use of the aluminum phyllosilicate material disclosed herein in a process for obtaining a CH₄-enriched gas fraction from a gas mixture comprising CO₂ and CH₄.

In a preferred embodiment, the (further) use is in biogas and/or landfill gas upgrading.

The device of the invention pertains to a device comprising the aluminum phyllosilicate material according to the invention and/or the adsorbent according to the invention. In an embodiment, the device according to the invention is adsorption reactor, preferably a swing adsorption reactor. In an embodiment, the device is a fixed-bed reactor. In an embodiment, the device is a pressure swing fixed-bed reactor.

### GENERAL DEFINITIONS

The terms ‘comprising’ or ‘to comprise’ and their conjugations, as used herein, refer to a situation wherein said terms are used in their non-limiting sense to mean that items following the word are included, but items not specifically mentioned are not excluded. It also encompasses the more limiting verb ‘to consist essentially of’ and ‘to consist of’.
Reference to an element by the indefinite article ‘a’ or ‘an’ does not exclude the possibility that more than one of the elements is present, unless the context clearly requires that there be one and only one of the elements. The indefinite article ‘a’ or ‘an’ thus usually means ‘at least one’.
The terms ‘to increase’ and ‘increased level’ and the terms ‘to decrease’ and ‘decreased level’ (or to ‘reduce” and “reduced level”) preferably refer to a change of at least 5%, such as 10%, 15%, 20%, 25%, 30%, 35%, 40%, 45%, 50% higher or lower, respectively, than the corresponding level in a control or reference. In addition or alternatively, a level in a sample may be increased or decreased when it is statistically significantly increased or decreased compared to a level in a control or reference, irrespective of the size of change.

### Clauses

Herein, clauses are embodiments of the invention. Features of clauses (embodiments) herein can be combined.
1. Method for obtaining a CH₄-enriched gas fraction from a gas mixture comprising CO₂ and CH₄, the method comprising contacting the gas mixture with an adsorbent and obtaining a CH₄-enriched gas fraction, wherein the adsorbent comprises an aluminum phyllosilicate material with one or more intercalating moieties selected from the group consisting of an alkali metal cation, an alkaline-earth metal cation, and an ammonium cation, to thereby provide a basal spacing in the range of 10-15 Å.
2 Method according to clause 1, wherein CO₂ from the gas mixture is adsorbed on the adsorbent.
3. Method according to clause 1 or 2, further comprising a step of regenerating the adsorbent.
4. Method according to clause 3, wherein the regenerating comprises a step wherein the CO₂ is desorbed from the adsorbent to provide a CO₂-enriched gas fraction.
5. Method according to any one of the previous clauses, wherein the aluminum phyllosilicate is a smectite- and/or vermiculite-containing material.
6. Method according to clause 5, wherein the smectite-containing material and/or the vermiculite-containing material is bentonite and/or Fuller's earth.
7. Method according to clause 5 or 6, wherein the smectite-containing material comprises one or more selected from the group consisting of montmorillonite, beidellite, nontronite, volkonskoite, hectorite, saponite, and sauconite.
8. Method according to clause 7, wherein the smectite-containing material comprises montmorillonite.
9 Method according to any one of the previous clauses, wherein the cation is a hydrated cation.
10. Method according to any one of the previous clauses, wherein the alkali metal cation is Cs⁺ and/or K⁺ cation.
11. Method according to any one of the previous clauses, wherein the alkaline-earth metal cation is Ca²⁺ and/or Mg²⁺ cation.
12. Method according to any one of the previous clauses, wherein the alkaline-earth metal cation is hydrated Ca²⁺ cation.
13. Method according to any one of the previous clauses, wherein the alkaline-earth metal cation is hydrated Mg²⁺ cation.
14. Method according to any one of the previous clauses, wherein the ammonium cation is C1-C4 alkyl ammonium cation.
15. Method according to clause 14, wherein the C1-C4 alkyl ammonium cation is methylammonium cation and/or tetramethylammonium cation.
16. Method according to any one of the previous clauses, wherein the amount of the one or more of intercalating moieties in the aluminum phyllosilicate material is 0.1-3 mEq per g aluminum phyllosilicate material.
17. Method according to clause 16, wherein the amount of the one or more of intercalating moieties in the aluminum phyllosilicate material is 0.4-1.2 mEq per g aluminum phyllosilicate material.
18. Method according to any one of the previous clauses, wherein the adsorbent comprises 1-40 wt. % of a binder material and 60-99 wt. % of the aluminum phyllosilicate material, calculated on weight of the binder material and the aluminum phyllosilicate material.
19. Method according to clause 18, wherein the binder material is a non-activated aluminum phyllosilicate material and/or a plasticizing organic binder.
20 Method according to any one of the previous clauses, wherein the adsorbent is provided in one or more forms selected from the group consisting of a powder, a film, a fiber, a coating, a self-supported structure, a monolith and particles.
21. Method according to clause 20, wherein the particles have an average diameter of 0.1-50 mm.
22. Method according to any one of the previous clauses, wherein the gas mixture is contacted with the adsorbent at a CO₂ partial pressure of 0.1-10 bar.
23. Method according to any one of the previous clauses, wherein the gas mixture is contacted with the adsorbent at a temperature 0-70 °C.
24. Method according to any one of the previous clauses, wherein the gas mixture comprises 30-60 vol. % CO₂ and 40-70 vol. % CH₄, calculated on the gas mixture.
25. Method according to any one of the previous clauses, wherein the CH₄-enriched gas fraction comprises 1-30 vol. % CO₂ and 70-95 vol. % CH₄, calculated on the CH₄-enriched gas fraction.
26. Aluminum phyllosilicate material for obtaining a CH₄-enriched gas fraction from a gas mixture comprising CO₂ and CH₄,
   wherein the aluminum phyllosilicate material has one or more intercalating moieties selected from the group consisting of an alkali metal cation, an alkaline-earth metal cation, and an ammonium cation, to thereby provide a basal spacing in the range of 10-15 Å,
   wherein the aluminum phyllosilicate material has a selectivity in CO₂/CH₄ adsorption of at least 2, wherein selectivity in CO₂/CH₄ adsorption is defined as the ratio in CO₂/CH₄ adsorption capacity measured at a total pressure of 1 bar and at 20 °C for a 50/50 vol. % CO₂/CH₄ gas mixture.
27. Aluminum phyllosilicate material according to clause 26, wherein the aluminum phyllosilicate material has a CO₂ adsorption capacity of at least 0.8 mmol g⁻¹, measured at a pressure of 10 bar and at 20 °C for pure CO₂.
28 Aluminum phyllosilicate material according to clause 26 or 27, wherein the aluminum phyllosilicate material is a smectite- and/or vermiculite-containing material.
29. Aluminum phyllosilicate material according to clause 28, wherein the smectite-containing material and/or the vermiculite-containing material is bentonite and/or Fuller's earth.
30 Aluminum phyllosilicate material according to any one of clauses 26-29, wherein the smectite-containing material comprises one or more selected from the group consisting of montmorillonite, beidellite, nontronite, volkonskoite, hectorite, saponite, and sauconite.
31. Aluminum phyllosilicate material according to clause 30, wherein the smectite-containing material comprises montmorillonite.
32. Aluminum phyllosilicate material according to any one of clauses 26-31, wherein the cation is a hydrated cation.
33. Aluminum phyllosilicate material according to any one of clauses 26-32, wherein the alkali metal cation is Cs⁺ and/or K⁺ cation.
34. Aluminum phyllosilicate material according to any one of clauses 26-33, wherein the alkaline-earth metal cation is Ca²⁺ and/or Mg²⁺ cation.
35. Aluminum phyllosilicate material according to any one of clauses 26-34, wherein the alkaline-earth metal cation is hydrated Ca²⁺ cation.
36. Aluminum phyllosilicate material according to any one of clauses 26-35, wherein the alkaline-earth metal cation is hydrated Mg²⁺ cation.
37. Aluminum phyllosilicate material according to any one of clauses 26-36, wherein the ammonium cation is C1-C4 alkyl ammonium cation.
38. Aluminum phyllosilicate material according clause 37, wherein the C1-C4 alkyl ammonium cation is methylammonium cation and/or tetramethylammonium cation.
39. Aluminum phyllosilicate material according to any one of clauses 26-38, wherein the amount of the one or more of intercalating moieties in the aluminum phyllosilicate material is 0.1-3 mEq per g aluminum phyllosilicate material.
40. Aluminum phyllosilicate material according to clause 39, wherein the amount of the one or more of intercalating moieties in the aluminum phyllosilicate material is 0.4-1.2 mEq per g aluminum phyllosilicate material.
41. Use of an aluminum phyllosilicate material for obtaining a CH₄-enriched gas fraction from a gas mixture comprising CO₂ and CH₄, wherein the aluminum phyllosilicate material is as defined in any one of clauses 26-40.
42. Use according to clause 41, wherein a further use is in biogas and/or landfill gas upgrading.
43. Adsorbent for obtaining a CH₄-enriched gas fraction from a gas mixture comprising CO₂ and CH₄, the adsorbent comprising the aluminum phyllosilicate material as defined in any one of clauses 26-40.
44. Adsorbent according to clause 43, comprising 1-40 wt. % of a binder material and 60-99 wt. % of the aluminum phyllosilicate material, calculated on weight of the binder material and the aluminum phyllosilicate material.
45. Adsorbent according to clause 44, wherein the binder material is a non-activated aluminum phyllosilicate material and/or a plasticizing organic binder.
46. Adsorbent according to any one of clauses 43-45, wherein the adsorbent is provided in one or more forms selected from the group consisting of a powder, a film, a fiber, a coating, a self-supported structure, a monolith and particles.
47. Device for obtaining a CH₄-enriched gas fraction from a gas mixture comprising CO₂ and CH₄, the device comprising the aluminum phyllosilicate material as defined in any one of clauses 26-40 and/or the adsorbent as defined in any one of clauses 43-46.
48. Device according to clause 47, wherein the device is a fixed-bed reactor.

### FIGURE LEGENDS

FIG. 1: BET surface area (powder) as a function of number of cations per gram clay during exchange. For comparison, the MMTs and bentonite particles are also shown. Samples in the green area were used in the remainder of experiments. The CEC of MMT and the BET surface areas of non-exchanged MMT and bentonite are indicated by the vertical line, black dotted horizontal line, and black solid horizontal line, respectively.

FIG. 2: Adsorption isotherms of CO₂ and CH₄ on a) non-exchanged bentonite, b) Cs bentonite, c) MMA-bentonite, and d) TMA-bentonite powders.

FIG. 3: CO₂/CH₄ adsorption selectivity for a binary (50/50) mixture of CO₂ and CH₄ on a) Cs-bentonite, b) MMA-bentonite, and c) TMA-bentonite.

FIG. 4: CO₂ adsorption (1 bar, room temperature) normalized by the CO₂ adsorption after 30 minutes, on Cs-bentonite, MMA-bentonite, and TMA-bentonite particles and powder. The approximate CO₂ concentration is indicated by the gray solid line.

FIG. 5: Breakthrough curves for a binary (50/50) mixture of CO₂ and CH₄ (dark shade: 0.40 L min⁻¹, light shade: 0.20 L min⁻¹) on a) Cs-bentonite, b) MMA-bentonite, and c) TMA bentonite (Multiple repetitions are shown).

FIG. 6: Regeneration of a, b) Cs-bentonite, c, d) MMA-bentonite, and e, f) TMA-bentonite, with a, c, d) in a 0.60 L min⁻¹ N₂ stream and b, d, f) in a 0.30 L min⁻¹ N₂ stream. Note the different scales of the ordinates. The inset of Panel d) shows the data on a log-log scale.

FIG. 7: Adsorption-desorption cycles of a, b) Cs-bentonite, and c, d) TMA-bentonite. Panels a) and c) show the cycles consecutively, whereas in panels b) and d), cycles are shifted on top of each other.

FIG. 8: a-c) H₂O sorption and d-f) CO₂ adsorption (at 1 bar, ~20 °C) as a function of relative humidity for a, d) Mg-bentonite, b, e) Ca-bentonite, and c, f) Na-bentonite and Cs-bentonite. Open symbols and dashed lines indicate increasing relative humidity (i.e., the H₂O adsorption branch), closed symbols and solid lines indicate decreasing relative humidity (i.e., the H₂O desorption branch). The desorption branch (indicated by filled diamonds in panel b and d) corresponds to Ca-bentonite rehydrated at ~40% RH, whereas all other samples were rehydrated at ~80% RH.

FIG. 9: CO₂ sorption (at 1 bar, ~20 °C) as a function of sorbed H₂O for a) Mg-bentonite, b) Ca-bentonite, and c) Na-bentonite and Cs-bentonite. Open symbols indicate increasing relative humidity (i.e., H₂O adsorption), closed symbols indicate decreasing relative humidity (i.e., H₂O desorption). Desorption data (indicated by filled diamonds in panel b) corresponds to rehydration at 40% RH, whereas all other desorption data were rehydrated at 80% RH.

FIG. 10. CO₂ sorption (at 1 bar) as a function of drying time for Mg- and Ca-bentonite, with a) dried under N₂ purge as measured on the balance, b) dried under N₂ purge in a large plastic box, followed by 30 min evacuation, and c) equilibrated with N₂ at given relative humidity followed by continuous evacuation for the indicated time. The light-shaded bands corresponds to the capacity after vacuum, including its standard deviation.

FIG. 11. Adsorption isotherms of CO₂ and CH₄ on a) Mg-bentonite and b) Ca-bentonite, fit with the (multi-site) Langmuir equation (lines), and the resulting CO₂/CH₄ (1:1) selectivity on c) Mg-bentonite and d) Ca-bentonite. Samples were dried under N₂ purge for >2 weeks and evacuated for 60 min between measurements.

FIG. 12. Cyclic adsorption-desorption measurements on a), Mg-, b) Ca-, and c) Cs-bentonite particles.

### EXAMPLES

The invention is illustrated by the following working Examples that do not limit the scope of the invention.

### Example 1

Example 1 evaluates cation-exchanged MMT-rich bentonite for biogas upgrading via pressure-swing adsorption. Specifically, we study three different cation-exchanged bentonites of which the interlayer spacing is comparable to the molecular size of CO₂ and CH₄. In order of increasing interlayer spacing, these are: cesium-bentonite (Cs-bentonite, with d-spacing d≈11 Å (mono)methylammonium-bentonite, MMA-bentonite, d≈12 Å, and tetramethylammonium-bentonite (TMA-bentonite, d≈14 Å. Equilibrium adsorption isotherms of CO₂ and CH₄ (10-70 °C, up to 10 bar) and breakthrough measurements of the mixture on (powders and particles of) the different bentonites demonstrate unambiguously their ability to separate both gases. Kinetic measurements of CO₂ adsorption and the breakthrough measurements show that diffusional transport into the particles is sufficiently fast for cation-exchanged bentonites.

### Methods

### Materials

MMT-rich Na-activated bentonite clay (Cebogel QSE) was purchased from Eijkelkamp Soil & Water. Wyoming MMT (SWy-3) was purchased from the Clay Mineral Society Source Clay Repository. To exchange their interlayer cations, the clays were suspended in a dialysis tube (SnakeSkin, 3.5 kDa MCOW) in a solution of the chloride salt of the desired cation (Sigma Aldrich; MMACI and TMACI: synthesis grade; CsCl: ≥98%; unless specified otherwise, per gram clay, 3.2 mmol cations corresponding to ~4 times the cation exchange capacity of MMT, and 10 mL Milli-Q water) at room temperature for at least two weeks. Excess salt was washed off the cation-exchanged clay in multiple cycles by suspending the dialysis tube in Milli-Q water until the supernatant conductivity was below ≤100 μS cm⁻¹ (typically 6-8 cycles over ~1 week). Subsequently, the clays were dried in an oven at 60 °C, ground manually to a powder using a mortar, and used for analysis without size fractioning and further purification.

For the measurements that require particles instead of powder, the clays were pelletized by mixing the exchanged bentonites with a suspension of the as-received bentonite (100 g L⁻¹) in a 1:1.1 mass ratio of adsorbent to binder suspension (the water from the suspension is evaporated, and leaves a 1:0.1 ratio of adsorbent to dry binder material), where the as-received bentonite serves as a binder material. Particles (with particle diameter dp=2-4 mm or dp≈2 cm) were hand-rolled from the resulting paste and dried in an oven at 60 °C. The particles thus contain ~91% exchanged bentonite, and ~9% binder material.

### Sample Characterization

Nitrogen adsorption measurements at 77 K were performed using a Gemini VII 2390t surface area analyzer. Prior to each measurement, the sample was outgassed at 150 °C for 6-16 hours under a flow of dry N₂.

Thermogravimetric analysis (TGA) was performed using a Netsch STA 449 F3 Jupiter thermal gravimetric analyzer. As the bentonite samples can contain a significant fraction of impurities, this analysis was performed on the MMT samples. Approximately 20 mg of clay powder was placed in an Al₂O₃ crucible and heated from 0 °C to 1000 °C at a rate of 10 °C min⁻¹ under N₂ purge (50 mL min⁻¹). Outlet gases were analyzed using a Bruker Tensor 27 FT-IR spectrometer with a MCT (mercury-cadmium telluride) detector and a stainless steel light pipe gas cell at 200 °C. IR spectra were recorded with a resolution of 4 cm⁻¹ and averaged over 32 scans in the range 4000-650 cm⁻¹ throughout the heating process.

### Adsorption Isotherms

CO₂ and CH₄ adsorption isotherms were measured using a homebuilt Sieverts apparatus. The sample chamber was loaded with 10-15 g of clay powder (oven-dried at 150 °C for approximately 20 hours) and immersed in a Julabo F25-HE refrigerated heating circulator. Before each measurement, the sample chamber was evacuated at ~80 °C for one hour. During a measurement, the pressure in the sample chamber was increased stepwise (equilibration time ≳10 minutes) from vacuum to ~10 bar while continuously monitoring the pressure (two Gems 3100 digital pressure transducers; 0-25 bar; accuracy: 0.25% of full-scale) and temperature in the sample chamber and reservoir. The adsorbed quantity of CO₂ or CH₄ was calculated using the Van der Waals equation to account for non-ideality of the gases.

### Adsorption and Desorption Kinetics

Adsorption and desorption kinetics were measured gravimetrically on a scale (Adam Equipment Nimbus NBL 254i) enclosed by a plastic container (V=0.5 L). Approximately 5 g sample (oven dried at 150 °C for approximately 20 hours) was placed on the scale in a glass petri dish. First, the chamber was saturated with N₂, then CO₂ was provided to the chamber for 30 min, and finally the particles were regenerated in N₂ (all flow rates are 2 L min⁻¹ and controlled with a home built humidistat of which the “wet” channel was not used). At the gas switching points, no gas was provided for 30 s. A calibration measurement with an empty petri dish and an assumed linear drift as interpolated between begin- and endpoint were subtracted from each measurement.

Breakthrough Measurements of CO₂ and CH₄

Breakthrough measurements of a mixture of CO₂ and CH₄ (50±2%) were performed using a homebuilt fixed-bed reactor setup operating at room temperature and atmospheric pressure. Approximately 50 gram of clay particles (oven-dried at 150 °C for approximately 20 hours) were loaded in the cylindrical, stainless steel reactor (d=1.3 cm, L=60 cm, and V=80 mL). Supply of CO₂, CH₄, and/or N₂ to the inlet of the reactor was controlled by two Brooks SLA5800 Mass Flow Controllers that were calibrated volumetrically for the different gas types. At the outlet of the reactor, the effluent was diluted with a 0.60 L min⁻¹ flow of N₂. The diluted effluent was analyzed using a SICK S710 gas analyzer with a detection range of 0-50% CO₂ and CH₄. To study the regeneration of the sorbent, first the supply of the CO₂ and CH₄ mixture was stopped. Then, after 2 minutes, the dilution flow at the outlet of the reactor was stopped (or decreased to 0.30 L min⁻¹), and immediately thereafter a 0.60 L min⁻¹ (or 0.30 L min⁻¹) flow of N₂ was supplied to the inlet of the reactor.

### Results

### Sample Characterization

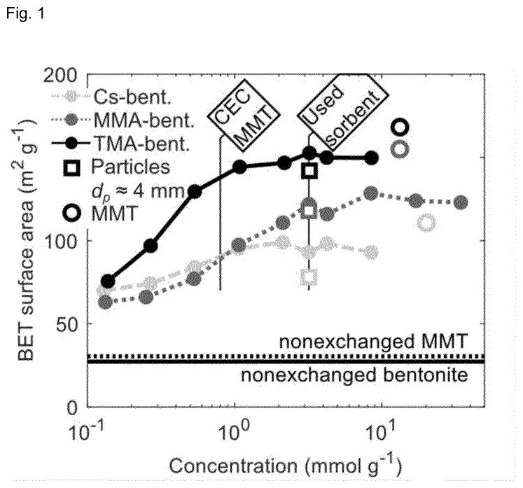

The surface areas and porous structure of the bentonite and MMT samples exchanged at various cation concentrations using nitrogen adsorption isotherms at 77K was assessed. All samples demonstrated mesoporous structures (H₄ adsorption-desorption hysteresis), microporous structures (no saturation in the limit p/p0→1), and external surface areas (t plot) that are nearly independent of the interlayer cation species and exchange concentration. Yet, adsorption on surfaces and in micropores, including the interlayer space (i.e., the low partial-pressure domain), to which the BET surface area is a convenient proxy (FIG. 1) increases (i) with increasing cation size, and (ii) with increasing cation concentration up to a saturation concentration. Given the similar external surface areas of all samples, the exchange with large(r) cations must facilitate the adsorption of N₂ in the interlayer space. The saturation concentration can be interpreted as the concentration at which all interlayer spaces are opened up by sufficient cations. For Cs-bentonite and TMA-bentonite, this is ~1 mmol per g, close to the cation exchange capacity (CEC) of MMT (~0.8 mEq g⁻¹). For MMA bentonite, this is ~3 mmol per g. Bentonites exchanged with 3.2 mmol cations per g are used in the remainder of the Examples.

To test the thermal stability of the clays, a TGA of the MMT samples was performed. For all MMTs, loss of water is observed at 90 °C-100 °C. The MMA-MMT sample demonstrates a peak mass loss due to decomposition of the cations at ~345 °C and a second peak at ~495 °C. For TMA-MMT, a single decomposition peak was observed at ~460 °C that is well-segregated from water desorption. As expected, no ‘decomposition’ of Cs⁺ was found. Finally, dehydroxylation occurred at 610 °C-665 °C for all MMTs.

### Single Component Gas Adsorption

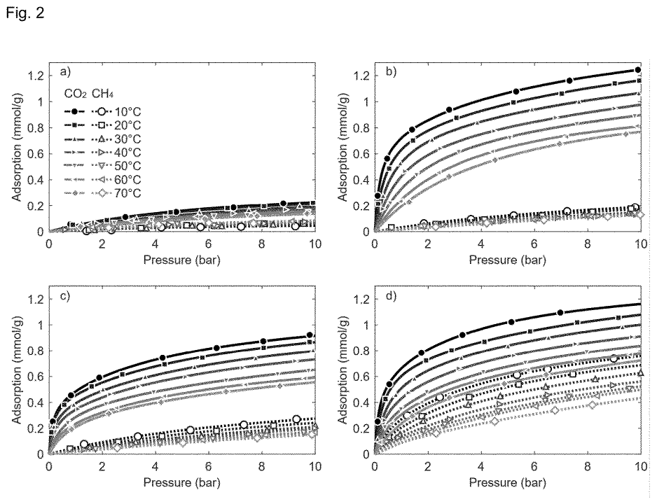

The adsorption isotherms of the individual components (CO₂ and CH₄) on the non-exchanged bentonite, Cs-bentonite, MMA-bentonite, and TMA-bentonite were analyzed (FIG. 2). Non-exchanged bentonite, dominated by Na⁺ cations that are much smaller than the studied gas molecules, hardly sorbs either gas over the entire P (0-10 bar) and T-range (10-70 °C) with a maximum adsorption capacity 0.23 mmol g⁻¹ and 0.08 mmol g⁻¹ for CO₂ and CH₄, respectively. The measured capacities are in line with the adsorption capacity on (various types of) MMT and other smectites (e.g., hectorite) with small cations for CO₂ and for CH₄ in absence of interlayer water. In these cases the interlayer space is inaccessible to either gas and adsorption is limited to external surfaces.

The CO₂ adsorption capacity of bentonite exchanged with large cations is significantly larger than that of non-exchanged bentonite. It follows the order Cs bentonite>TMA-bentonite>MMA-bentonite with maximum adsorption capacities at 10 °C and 10 bar of ~1.25 mmol g⁻¹, ~1.16 mmol g⁻¹, and ~0.92 mmol g⁻¹, respectively. All exchanged bentonites feature similarly-shaped isotherms that are curved in the low-pressure domain, followed by a domain of more gradual increase. The steepness of the isotherm in the low-pressure domain and the high-pressure capacity decrease with increasing adsorption temperature. A comparison between these results and CO₂ adsorption on non-exchanged bentonite, where adsorption is restricted to an external surface of approximately equal size, suggests that the larger adsorption capacity of the cation-exchanged bentonites can be attributed to adsorption in the interlayer space that is now sufficiently opened up by the large cations.

All bentonites adsorb less CH₄ than CO₂. Cs-bentonite and MMA-bentonite hardly sorb CH₄ over the entire P and T-range (~0.18 mmol g⁻¹ and ~0.27 mmol g⁻¹, respectively, at 10 °C and 10 bar), similar to non-exchanged bentonite. The CH₄ adsorption isotherms of TMA-bentonite are moderately curved with a maximum adsorption capacity of ~0.76 mmol g⁻¹ at 10 °C and 10 bar. A comparison of these results with CH₄ adsorption on non-exchanged bentonite suggest that only the interlayer space of TMA-bentonite is readily accessible to CH₄ and adsorption of CH₄ on Cs-bentonite and MMA-bentonite is (mostly) restricted to external surfaces.

The adsorption isotherms were fit with the (multi-site) Langmuir adsorption isotherm:

$$q = {\sum }_{i} \frac{{n}_{i} {b}_{i} P}{1 + {b}_{i} {P}^{′}}$$

where nᵢ is the number of adsorption sites of type i and bi is the equilibrium constant for sites of type i. When the gas is only adsorbed on the external surface, i=1 (i.e., for CO₂ on non-exchanged bentonite, and CH₄ on non-exchanged, Cs-, and MMA-bentonite). When the gas is adsorbed on the external surface and in the interlayer space, i∈{1,2} (i.e., for CO₂ on Cs-, MMA-, and TMA-bentonite, and CH₄ on TMA-bentonite).

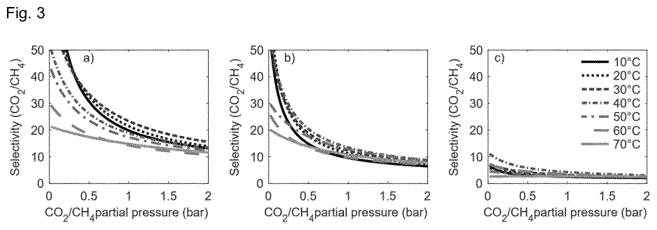

The CO₂/CH₄ adsorption selectivity S of the materials that does not take into account competitive or synergistic effects can be determined from the Langmuir fit to the equilibrium CO₂ and CH₄ adsorption isotherms (FIG. 3). The selectivity follows the order Cs-bentonite>MMA-bentonite>TMA-bentonite, i.e., the selectivity decreases with increasing cation size. At typical conditions for biogas upgrading (T=30 °C, feed pressure PCO₂═PCH₄=0.5 bar), the selectivity of Cs bentonite, MMA-bentonite, and TMA-bentonite is S≈35, S=23, and S=4, respectively.

### Adsorption and Desorption Kinetics

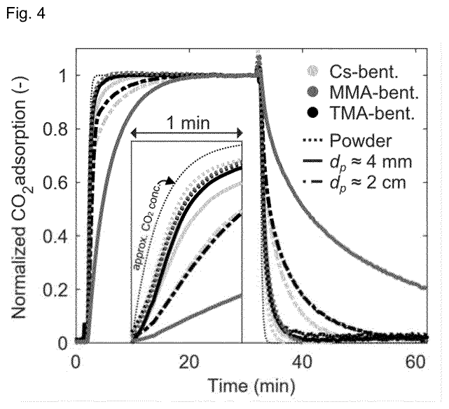

CO₂ adsorption and desorption kinetics are measured on the clay powders (to probe the ‘intrinsic’ adsorption) and the clay particles of two different sizes (to probe diffusional transport limitations) (FIG. 4). CO₂ adsorption and desorption on all clay powders is fast and follows the approximate CO₂ concentration in the container (for which equilibration takes ~1 min). CO₂ adsorption and desorption time scales of the small Cs- and TMA-bentonite particles (dp≈4 mm) are nearly identical to the adsorption and desorption time scales on the powder, suggestion that these particles are sufficiently porous to allow for fast diffusional transport of the gas species into the particle. Smaller particles (dp≈4 mm) of MMA bentonite display CO₂ adsorption and desorption time scales >10 min.

Simultaneous CO₂ and CH₄ Adsorption

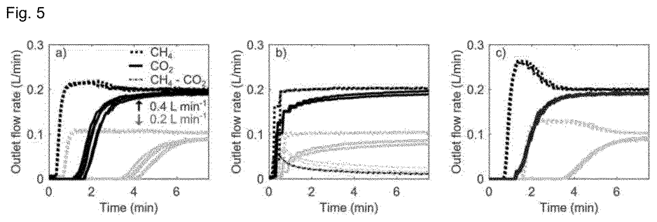

The breakthrough measurements of the gas mixture in the fixed-bed reactor setup at high (0.40 L min⁻¹) and low (0.20 L min⁻¹) flow rates (FIG. 5) were considered. For Cs-bentonite and TMA-bentonite, after the biogas flow is switched to the reactor and the N₂ initially present in the reactor is displaced, first the signal of CH₄ grows rapidly while no CO₂ is detected. This implies that purified CH₄, mixed with the N₂ dilution gas, flows through the analyzer, with the CO₂ retained in the bed. Once CO₂ adsorption in the bed progresses towards saturation, also CO₂ is detected in the effluent. It was found that the time at which CH₄ and CO₂ are first detected and the shape of the breakthrough curve depend on the material and the flow rate (a direct comparison of the Cs-bentonite and TMA-bentonite was made). For MMA-bentonite, on CO₂ and CH₄ are first detected nearly simultaneously (FIG. 4).

For Cs-bentonite, that has a high CO₂/CH₄ selectivity and a limited CH₄ adsorption capacity, CH₄ is first detected after approximately 19 s (0.40 L min⁻¹) and 37 s (0.20 L min⁻¹). This is approximately the time required for the displacement of the reactor void volume (~62 mL) by CH₄, indicating limited adsorption of CH₄. In contrary, the first detection of CH₄ on TMA-bentonite is at approximately 41 s and 90 s, respectively. Consequently, the TMA-bentonite must have adsorbed considerable CH₄. Yet, immediately after breakthrough, the produced flow of CH₄ is larger in the system with TMA-bentonite than with Cs-bentonite, indicating that at least part of the adsorbed CH₄ on TMA-bentonite is desorbed again. This desorption may have two origins: (i) local concentration swings of CH₄ due to the adsorption of CO₂ upstream followed by the progression of the CO₂ adsorption front, and (ii) competitive adsorption leading to the displacement of adsorbed CH₄ by CO₂.

In line with their nearly identical CO₂ adsorption capacity, CO₂ breakthrough on Cs- and TMA-bentonite occurs nearly simultaneously, after approximately 1.3 min (0.40 L min⁻¹) and 3.6 min (0.20 L min⁻¹). For Cs bentonite, temporal shifts in CO₂ breakthrough between different experiments was observed. These shifts correlate well with the temperature of the environment (~20-27 °C), with accelerated breakthrough at higher temperature due to a lower adsorption capacity.

Comparing the experiments while normalized for their flow rates and as a function of the cumulative input biogas volume, it turns out that the measurements at different flow rates nearly overlap, apart from two distinct features. First, the sharpness of the breakthrough fronts of both CH₄ and CO₂ decreases with increasing flow rate, likely due to enhanced axial dispersion at higher flow rates, and/or limitations in diffusional transport in the particles. Second, the breakthrough of CO₂ is delayed with decreasing flow rate, likely due to thermal effects: a lower flow rate permits more time to dissipate the released adsorption heat, hence the sorbent can be utilized at a lower average temperature.

### Sorbent Regeneration

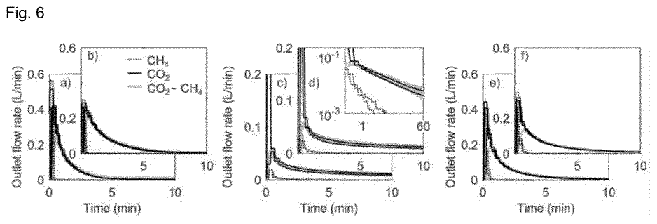

The regeneration of the bed with N₂ after it has been fully saturated with the biogas mixture was considered. Regeneration experiments were performed at high (0.60 L min⁻¹) and low (0.30 L min⁻¹) flow rates (FIG. 6). For all experiments, after the N₂ flow is switched to the reactor, immediately a large flow of CO₂ and CH₄ is detected as a result of the biogas present in the void space of the reactor being displaced. For Cs-bentonite, no CH₄ is detected after approximately 24 s. For MMA-bentonite and TMA-bentonite, CH₄ is detected until approximately 3 min and 2 min, respectively. Based on the material selectivity and diffusional transport in the particles, it appears that this CH₄ originates (i) for MMA-bentonite mostly from CH₄ that is slowly displaced from the particle void space, and (ii) for TMA-bentonite from CH₄ that was desorbed from the interlayer space. The amount of desorbed CO₂ and the typical desorption time of CO₂ are, on all materials, clearly larger than for CH₄. The typical CO₂ desorption times for Cs-bentonite and TMA-bentonite are 5 min and 7 min (0.60 L min⁻¹) and 8 min and 10 min (0.30 L min⁻¹), respectively. For MMA-bentonite, CO₂ is still detected after 1 hr of desorption.

### Comparison Isotherm, Adsorption and Desorption

Table 1 summarizes CO₂ and CH₄ adsorption and desorption in the reactor, and the adsorption based on the single component isotherms under reactor conditions. With the sole exception of CH₄ on TMA-bentonite, adsorption and desorption in the reactor is in reasonable agreement (overlapping error margin) with the single component isotherms, indicating that competitive and synergistic effects do not play a significant role here. It can be noted, however, that the relative error of, in particular, CH₄ adsorption and desorption on Cs- and MMA-bentonite in the reactor appears large. Regarding CH₄ adsorption on TMA-bentonite, it appears that the adsorption capacity of CH₄ decreases due to the competitive adsorption with CO₂ in the interlayer space. Hence, the effective selectivity of TMA-bentonite is higher than its single component selectivity (S≈4) and estimated as S≥7.

TABLE 1
Adsorption capacity based on the single component isotherms, and as measured in the
fixed bed reactor during adsorption and desorption (reported values in mmol g⁻¹).

| | Single component | | Adsorption | | | Desorption | | |
|---|---|---|---|---|---|---|---|---|
| Material | qCO₂^{a} | qCH₄^{a} | Δq | qCO₂^{b} | qCH₄^{b} | Δq | qCO₂^{b} | qCH₄^{b} |
| Cs bentonite | 0.40 ± 0.01 | 0.01 ± 0.01 | 0.39 ± 0.04 | 0.42 ± 0.03 | 0.03 ± 0.02 | 0.43 ± 0.04 | 0.46 ± 0.05_{c} | 0.04 ± 0.03_{c} |
| MMA bentonite | 0.33 ± 0.01 | 0.02 ± 0.01 | 0.29 ± 0.10_{c} | 0.28 ± 0.08_{c} | 0.00 ± 0.02_{c} | 0.33 ± 0.06_{c} | 0.35 ± 0.06_{c} | 0.00 ± 0.02_{c} |
| TMA bentonite | 0.40 ± 0.01 | 0.12 ± 0.01 | 0.35 ± 0.02 | 0.40 ± 0.01 | 0.05 ± 0.01 | 0.34 ± 0.01 | 0.39 ± 0.03 | 0.04 ± 0.0 |

^{a}At 0.5 bar, 23 °C Interpolated from the isotherms in FIG. 2 and multiplied by 0.91 to account for the binder material.
^{b}Gas volume in the void space is subtracted (assuming Vvoid = 62 mL with cCO₂═cCH₄ = 0.5).
_{c}The integration of the adsorption and desorption signals were cut after 20 min and 30 min, respectively, because of the slow adsorption and desorption kinetics.

### Cyclic Stability

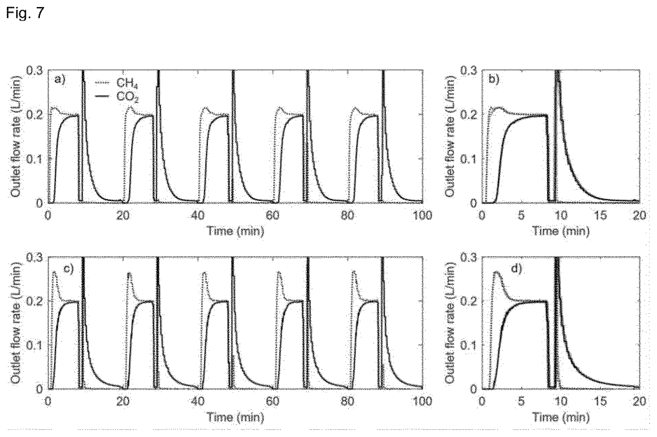

The cyclic stability of Cs- and TMA-bentonite was considered (FIG. 7). To this end, consecutive adsorption-desorption cycles were measured. Each cycle consisted of an adsorption time of 8 minutes with a 0.40 L min⁻¹ biogas flow, followed by a desorption time of 10 minutes with a 0.60 L min⁻¹ N₂ flow. When switching between adsorption and desorption and vice versa, a waiting period of 1 minute was employed. The exchanged bentonite demonstrates excellent cyclic stability.

### Concluding Remarks

Cation-exchanged bentonite clay can be used for biogas upgrading in a pressure-swing fixed bed reactor. These clays can be highly selective compared to Activated Carbon (typically: S<6) and are able to release the captured CO₂ faster and/or under milder conditions than, e.g., Zeolite 13X, in the latter case at the expense of selectivity. The comparison with CMS in terms of their kinetic performance is less straightforward. For example, adsorption time scales (0-90% of the capacity) of ~1 min (cylindrical particles with dp=0.9 mm; CMS KP 407) and ~2 min (dp=1.8 mm; Takeda CMS 3K) were reported. For TMA-bentonite with dp≈4 mm, this is ~1.2 min. Yet, (i) larger particles are intrinsically subject to longer mass diffusion times and slower dissipation of the adsorption heat, and (ii) the clays were studied under transient partial pressure (N₂→CO₂) with an equilibration time of ~1 min, whereas CMS were studied under transient absolute pressure. Without being bound by theory, it appears that adsorption on clay particles can be at least as fast as, and probably a few times faster than adsorption on equally-sized CMS particles. Despite the relatively small adsorption capacity of the clays compared to conventional sorbents, the fast CO₂ adsorption and desorption kinetics allow for short cycle times and hence increased productivity.

On the process side, the clay sorbents work best for near-ambient pressure conditions (vacuum to pCO₂≤1 bar) and desorption can be performed without the input of external heat, which (i) reduces the energy demand of the setup, and (ii) simplifies the setup and hence reduces capital and operational costs, compared to reactors that do require higher pressures and/or external heating. Furthermore, the diffusional transport into the Cs- and TMA-bentonite particles is fast, which allows for the use of relatively large sorbent particles. This appears of relevance, as the pressure drop over the reactor length decreases with increasing particle size. In conclusion, it is demonstrated that MMT-rich bentonite clays with appropriately sized cations can provide a viable alternative to conventional sorbents for biogas upgrading in a pressure-swing fixed bed reactor, in particular due to the combination high selectivity and fast adsorption and desorption kinetics of this sorbents.

### Example 2

Example 2 assesses the applicability of Mg-, Ca-, and Na-bentonites for the selective adsorption of CO₂ over CH₄ at near-ambient conditions and as a function of sorbed H₂O with particular focus on the application of biogas upgrading. Cs-bentonite as described in Example 1 was included as reference material that allows for large CO₂ adsorption under the driest conditions.

Example 2 more specifically assesses:
(i) the CO₂ adsorption at ambient temperature and 1 bar as a function of relative humidity (RH) and sorbed H₂O,
(ii) the stability of the states that yield the maximum CO₂ adsorption,
(iii) the CO₂ and CH₄ adsorption as a function of pressure (0-10 bar) and temperature (10-70 °C) for the states that yield maximum CO₂ adsorption capacity, and
(iv) the applicability of these sorbents for CO₂/CH₄ separation using a laboratory-scale adsorption column. This was related to the dry Cs- and TMA-bentonite as described in Example 1, to which is also referred for a comparison of these (similar) materials with alternative sorbents such as zeolites, activated carbon, and carbon molecular sieves.

### Methods

### Materials

MMT-rich Na-activated bentonite clay (Cebogel QSE) was purchased from Eijkelkamp Soil & Water. This bentonite features similar characteristics as reference clay SWy (Clay Mineral Society), but with a larger impurity fraction. The interlayer cations were exchanged for Mg²⁺ or Ca²⁺ by suspending the clay, loaded into a dialysis tube (SnakeSkin, 3.5 kDa MCOW), in a solution of MgCl₂ or CaCl₂) (hexa- and dihydrate; Sigma Aldrich; ≥99%) at room temperature for at least four weeks. The exchange suspension contains, per gram bentonite, 10 mL Milli-Q water and 3.2 mmol cations, corresponding to ~4 times the cation exchange capacity of MMT SWy-3. Excess salt was washed off the cation-exchanged clay by resuspending the dialysis tube in fresh Milli-Q water six times with the supernatant conductivity during the final washing cycle remaining below ≤100 μS cm⁻¹. Subsequently, the clays were dried in an oven at 60 °C and ground manually to a powder using a mortar.

Mg- and Ca-bentonite particles were produced by mixing the exchanged bentonite powders with photo glue (Collall B.V.) in a 7:2 mass ratio. The photo glue contains approximately 5% natural rubber in a mixture of non-polar organic solvents and serves as a flexible binder material. For relatively small particles with edge length Iₚ=2-4 mm, the bentonite-glue mixture was casted into a mold and left to dry to the atmosphere. From the obtained slices, (nearly) cubic particles were cut using a scalpel. Relatively larger particles with diameter dₚ≈2 cm were produced by crafting the mixture to a near-spherical shape. After evaporation of the solvent, the particles contain ~98.6% exchanged bentonite, and ~1.4% natural rubber.

The Na-bentonite powders correspond to the ground as-received material and the preparation procedures for Cs-bentonite powders and particles are detailed in Example 1.

H₂O and CO₂ Sorption

The sorption of H₂O, the adsorption (equilibrium and kinetics) of CO₂, and the stability of the pre-hydrated samples under dry N₂ purge [all at room temperature and atmospheric (background) pressure] were measured gravimetrically on a scale (Adam Equipment Nimbus NBL 254i; continuous data-acquisition with a sampling frequency of ~1 Hz) enclosed by a plastic container (V≈0.3 L) in which the RH can be controlled with a home built humidistat (Veldscholte et al. HardwareX. 2022 Mar. 9:11:e00288) via the inlet gas (flow rate: 2 L min⁻¹) that can furthermore be switched between N₂ and CO₂ (Grade 4.5; Linde Gas). The RH inside the container (that could be varied between ~0% and ~80% was monitored using a Sensirion SHT-85 humidity sensor. The accuracy of the sensor is around ±1.5% pt.
(i) For the H₂O sorption isotherms and corresponding CO₂ adsorption, 3.7±0.5 g of the bentonite powder that was pre-dried (in situ under dry N₂ purge at room temperature for >40 h for ≥18 h, or ex situ at 150 °C or 200 °C in an oven without gas purge for 24 h) was placed on the scale in a glass petri dish. The H₂O sorption isotherms (under N₂ purge) were measured by first the stepwise increase of the RH from ~0% to ~80%, and consecutively the stepwise decrease back to ~0% RH. At each intermediate RH, the sample was equilibrated for ≥18 h (up to 48 h when the RH was decreased to ~0%; at intermediate RH the typical apparent equilibration time of H₂O on the powder samples is several hours), where mass difference between the equilibrated sample (corrected for drift induced by the variable RH environment) and the dry sample corresponds to the H₂O sorption. The dry sample mass was determined by (post-) drying the sample after the measurement cycle at 200 °C in an oven without gas purge for 24 h. The CO₂ adsorption at given RH was measured by switching the gas flow from N₂ to CO₂ for 15 min after H₂O equilibration and determined from the subsequent sample mass increase (a calibration experiment with an empty petri dish was subtracted from each measurement). The typical (apparent) equilibration time of CO₂ on the powder samples is several minutes (i.e., <<15 min); much shorter than that of H₂O.
(ii) For the stability measurements, 3.7±0.5 g of the bentonite powder was placed on the scale in a glass petri dish and pre-humidified in situ at ~80% for >18 h. At the start of the measurement, the target RH was set to 0%. The CO₂ adsorption as a function of drying time was determined (regularly) following the procedure detailed in (i). (In particular during the first few hours of the experiment, the CO₂ adsorption is underestimated due to the then significant simultaneous desorption of H₂O)

### Adsorption Isotherms

The CO₂ and CH₄ adsorption isotherms were measured using a homebuilt Sieverts apparatus. The sample chamber was loaded with ~7 g of clay powder and immersed in a Julabo F25-HE refrigerated heating circulator. The initial hydration state of the (i.e., pre-hydration and pre-drying before loading into the sample chamber) were specified per (set of) experiment(s). Before each experiment (series), the sample chamber was evacuated at ~20 °C for 30 minutes. During an experiment, the pressure in the sample chamber was increased stepwise (with intermediate equilibration times of ~10 minutes) from vacuum up to ~10 bar, while continuously monitoring the pressure (two Gems 3100 digital pressure transducers; 0-25 bar; accuracy: 0.25% of full-scale) and temperature in the sample chamber and reservoir. The adsorbed quantity of CO₂ or CH₄ was calculated using the Van der Waals equation of state to account for non-ideality of the gases.

Cyclic Adsorption and Desorption Measurements of CO₂ and CH₄

Cyclic adsorption (breakthrough; with an equimolar mixture comprising only CO₂ and CH₄, 50±2%; total flow rate: 0.40 L min⁻¹) and desorption (regeneration; using a N₂ purge; flow rate: 0.60 L min⁻¹) measurements of were performed using a homebuilt fixed-bed adsorption column (stainless steel; cylindrical with d=1.3 cm, L=60 cm, and V=80 mL) operating at room temperature and atmospheric pressure and loaded with approximately 40±1 gram of the bentonite particles. Gas flow rates were controlled by three Brooks SLA5800 mass flow controllers and the reactor effluent was monitored using a SICK S710 gas analyzer. To meet the requirements of this gas analyzer, the reactor effluent at the outlet of the column was diluted with a 0.60 L min⁻¹ flow of N₂ (except during the desorption step). Prior to loading, particles were first exposed to humidified air (RH ~95%) for at least two weeks (Mg- and Ca-bentonite only), and second dried under N₂ purge for at least two weeks.

### Results

H₂O Ad- and Desorption and CO₂ Adsorption

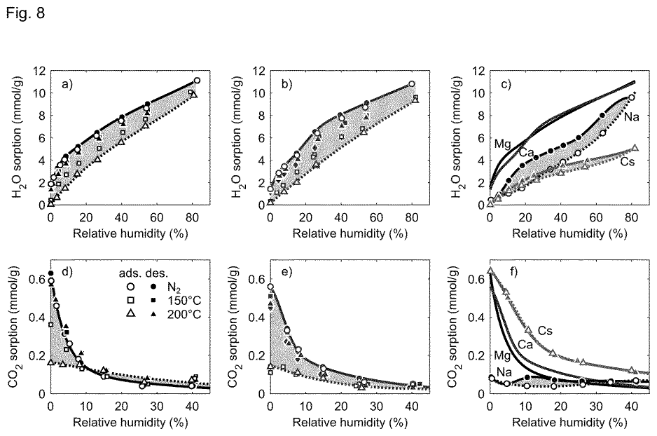

We first assessed the H₂O (FIG. 8a-c) sorption of the different bentonites as a function of increasing and subsequently decreasing relative humidity, subject to different pre-drying conditions (under dry N₂ purge at room temperature, and at 150 °C or 200 °C in an oven without gas purge).

Generally, the H₂O sorption increases with increasing relative humidity and with the hydration energy of the cation (Mg²⁺≈Ca²⁺>Na⁺>Cs+).

The highly similar H₂O sorption isotherms of Mg- and Ca-bentonite feature a nearly-concave shape, apart from at the highest RH (~80%) due to pore condensation, and for Ca-bentonite ~20% RH in the H₂O desorption branch that has been attributed to the 2W-1W transition. Under the conditions studied, their H₂O sorption isotherms are bound by the H₂O desorption branch of the samples dried under N₂ purge (upper bound), and the H₂O adsorption branch of the samples dried at 200 °C. (lower bound). The H₂O desorption branches of the samples dried under N₂ are nearly, but not fully, recovered at low RH by the samples dried at 150 °C and 200 °C (i.e., after rehydration at ~80% RH). The H₂O desorption branch of Ca-bentonite after drying at 150 °C and rehydration at ~40% RH is systematically slightly lower than after rehydration at ~80% RH. The maximum H₂O sorption (at 80% RH) is around 10 mmol g⁻¹ corresponds to a 2 W state. The H₂O adsorption-desorption hysteresis increases with increasing pre-drying temperature; while it is fairly limited over the complete range of RH for samples dried under N₂, it increases to around 2.5 mmol g⁻¹ at intermediate RH for samples dried at 200 °C. The (post-) drying of the samples at 200 °C after the H₂O desorption measurements furthermore revealed the retention of ~1.6±0.3 mmol H₂O per g Mg-bentonite and ~1.3±0.1 mmol H₂O per g Ca-bentonite; this indicates the ability of Mg- and Ca-bentonites to retain H₂O even under the driest conditions (under dry N₂ purge) at room temperature studied here.

The H₂O sorption isotherms of Cs-bentonite as well feature a nearly-concave shape similar to Mg- and Ca-bentonite, but with a smaller maximum H₂O sorption (at 80% RH) of around 5 mmol g⁻¹ that corresponds to only a 1 W state. The H₂O adsorption-desorption hysteresis is fairly limit over the complete range of RH (<0.6 mmol g⁻¹), even for this sample dried at 200 °C.

The H₂O sorption isotherms of Na-bentonite feature a more complex shape than the other bentonites. In particular, the H₂O desorption branch features steps at ~60% RH and at ~15% RH, likely corresponding to the predominantly 2 W-1 W and predominantly 1 W-0 W transitions. Indeed, the maximum H₂O sorption (at 80% RH) is 9.6 mmol g⁻¹-which is nearly the maximum H₂O sorption on the (2W) Mg- and Ca-bentonites, and on the (pseudo-) plateau between the steps (~50-25% RH) the H₂O sorption varies from ~6-4 mmol g⁻¹-close to the H₂O sorption at ~20% RH on the H₂O desorption branch of Ca-bentonite (i.e., the step) and the maximum H₂O sorption on the Cs-bentonite that does not adsorb more than 1 W. The H₂O adsorption-desorption hysteresis is up to ~2.0 mmol g⁻¹, which is larger than for Mg- and Ca-bentonites pre-dried under the same (nearly-dry N₂) conditions and Cs-bentonite pre-dried at 200 °C, but around the maximum hysteresis for Mg- and Ca-bentonite pre-dried at elevated temperatures.

Similar to the Mg- and Ca-bentonite and likely due to the smaller MMT fraction of our bentonites, the maximum H₂O sorption (at 80% RH) of Cs- and Na-bentonite is somewhat smaller than reported before. Contrary to the Mg- and Ca-bentonite pre-dried at elevated temperatures and similar to the Mg- and Ca-bentonite pre-dried under N₂, the H₂O adsorption and desorption isotherms of Cs- and Na-bentonite do close at low RH. The (post-) drying of the samples at 200 °C after the H₂O desorption measurements revealed essentially no (Cs-bentonite) or only a little (~0.4 mmol H₂O per g Na-bentonite) retained H₂O. In other words, Cs- and Na-bentonite are able to retain less H₂O under the driest conditions (under dry N₂ purge) at room temperature studied here compared to Mg- and Ca-bentonite, in line with their smaller hydration free energy of their exchanged cations.

The CO₂ adsorption is subsequently studied (FIG. 8d-f, at 1 bar, ~20 °C). In general, the CO₂ adsorption on the Mg-, Ca-, and Cs-bentonite decreases with increasing relative humidity. For Mg- and Ca-bentonite, the CO₂ adsorption depends strongly on the drying conditions and the hydration history of the sample. On the one hand, the CO₂ adsorption of Mg- and Ca-bentonite dried under N₂ and Cs-bentonite (dried at 200 °C) is nearly indifferent for the H₂O adsorption and desorption branches, in accordance with the limited H₂O adsorption-desorption hysteresis under these conditions. Their maximum CO₂ adsorption (at 1 bar, ~20 °C, ~0% RH) is ~0.6 mmol g⁻¹, which is upon increasing the RH reduced to 0.2 mmol g⁻¹ at a RH of 7%, 9%, and 18% for Mg-, Ca-, and Cs-bentonite, respectively (i.e., decreasing with increasing cationic potential). Beyond this RH, the CO₂ adsorption is further, but more gradually, reduced with increasing RH to essentially no CO₂ adsorption at the highest RH. On the other hand, the CO₂ adsorption in the H₂O adsorption branch of Mg-bentonite dried at 200 °C and Ca-bentonite dried at 150 °C and 200 °C is smaller with a maximum CO₂ adsorption (at 1 bar, ~20 °C, ~0% RH) of only ~0.15 mmol g⁻¹ and decreasing gradually with increasing RH to essentially no CO₂ adsorption at the highest RH. Mg-bentonite dried at 150 °C displays intermediate behavior, with a maximum CO₂ adsorption (at 1 bar, ~20 °C) at ~0% RH of ~0.36 mmol g⁻¹ that is reduced to 0.2 mmol g⁻¹ also at a RH of 7%. In the H₂O desorption branch, however, the capacity of all materials as dried under N₂ is nearly recovered. Similar to H₂O sorption, it is believed that all states indicated the shaded areas are accessible, depending on the drying conditions and hydration history of the sample. The CO₂ adsorption of the Na-bentonite is over the complete range of RH smaller than the maximum CO₂ adsorption on the other bentonites (i.e., <0.1 mmol g-1) showing minor peaks at ~0% RH, at ~50% RH, and for the H₂O desorption branch at ~10% RH.

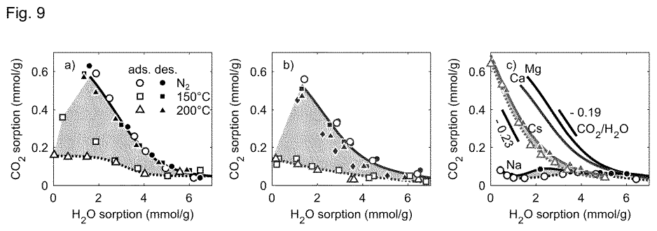

FIG. 9 displays the CO₂ adsorption as a function of sorbed H₂O using the data presented in FIG. 8. With regard to the different drying conditions, FIG. 9 shows the same trends as FIG. 8.

### Stability of Adsorbed H₂O

So far, the CO₂ adsorption as a function of relative humidity and sorbed H₂O was assessed, and it was established that the CO₂ adsorption on Mg- and Ca-bentonite is maximized when these materials are characterized by the state where the cations are hydrated, but the remainder of the interlayer space is not; near 0% RH and in the H₂O desorption branch only. With respect to their application in biogas upgrading; since a pressure swing adsorption setup scans a range of pressures and thus water activities, the stability of such a state under gas-purging and vacuum conditions needs to be assessed. To this end, different methods were used.

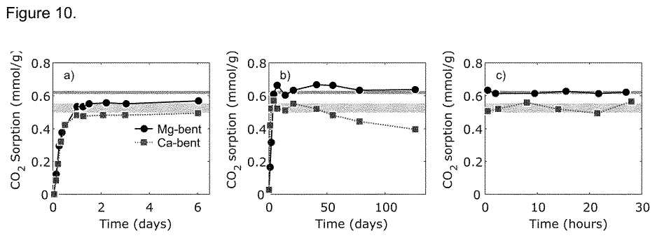

In FIG. 10a, the CO₂ adsorption (at 1 bar, ~20 °C) as measured in the gravimetric setup (scale) flushed with 2 L min⁻¹ dry N₂ on a (initially hydrated) sample with a dry mass ~4 g is presented. The CO₂ adsorption was measured regularly following the method as in FIG. 8. (For short time-scales, the CO₂ adsorption in FIG. 10a is likely underestimated due to the simultaneous adsorption of CO₂ and desorption of H₂O, which cannot be segregated.)

In FIG. 10b, the CO₂ adsorption (at 1 bar, 20 °C) as a function of drying time for samples that were dried ex situ under dry N₂ purse is presented. The adsorption was measured in the volumetric setup and interpolated from a DSL fit to the adsorption isotherm. Prior to the isotherm measurement, samples were evacuated (ultimate vacuum of the pump: 0.007 bar, corresponding to ~30% of the saturation pressure of H₂O at 20 °C) for 30 minutes which likely contributed to the H₂O desorption on the shorter time-scales.

In FIG. 10c, the CO₂ adsorption (at 1 bar, 20 °C) as measured in the volumetric setup (Sievert apparatus) and as a function of evacuation time is presented. To this end, the samples were pre-dried for 2-3 weeks ex situ and then transferred (all datapoints were measured consecutively on a single sample).

For the data presented in FIG. 10a-b, the CO₂ adsorption on both bentonites first increase to a plateau value within around 2 days of N₂ purge, likely due to the removal of non-cation bound H₂O. As expected, this plateau value (0.62 mmol g⁻¹ and 0.53 mmol g⁻¹ for Mg- and Ca-bentonite, respectively) is close to the maximum adsorption found in FIG. 8 for both bentonites. The CO₂ adsorption on the Mg-bentonite in both setups and on the Ca-bentonite on the gravimetric setup do not decrease at longer N₂ purge times. The CO₂ adsorption on the Ca-bentonite as measured in the volumetric setup (FIG. 10b), does decrease slowly after several weeks of N₂ purge and after 126 days it is reduced to 75% of the plateau value. (Note that, by now, the sample has seen 20 Nm³ g⁻¹ of dry N₂).

The bentonites dried in vacuum (FIG. 10c) start from the plateau value and do not decrease. While the vacuum pressure is orders of magnitude larger than in comparable works, it is around an order of magnitude smaller than the typical target vacuum pressure in industrial pressure swing adsorption setups, 0.05-0.1 bar.

This state is instable or only metastable at most at absolute 0% RH, but could be stable at well below ~1% RH because of the large hydration free energy- and hence barrier towards H₂O removal and collapse—of Mg²⁺ and Ca²⁺.

The most resilient water populations coordinate directly to the cations and can be referred to as tightly bound, whereas the other populations (as well as another portion of water molecules from the first hydration shell of the interlayer cations) are weakly bound.

It appears that the total amount of dry gas flushed around the sample is a better predictor for the collapse of this interlayer space than the drying time. Given that this collapse is induced around a several thousand L of dry gas per gram clay, and the TBW content of the clay around 1 mmol/g (100% RH=2.34% of gas), the required RH for this collapse can be conservatively estimated to be well below 0.1% for Ca-bentonite (corresponding to water partial pressure of around 2 Pa).

CO₂ and CH₄ Adsorption on Slightly Hydrated Bentonites

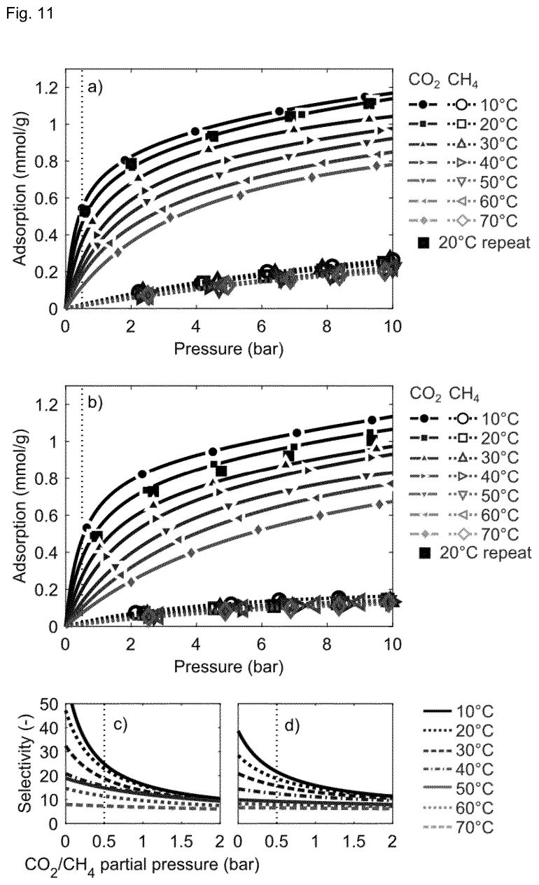

Next, the adsorption of isotherms of CO₂ and CH₄ were measured separately on Mg-bentonite and Ca-bentonite powders (FIG. 11a-b). To this end, the samples were dried at room temperature under N₂ purge for several weeks such that their CO₂ adsorption capacity at 1 bar and 20 °C was (near) the plateau value in FIG. 10 indicated by the horizontal lines therein. For each gas species, a fresh sample was used on which the isotherms were measured in the order 20 °C, 10 °C, 30 °C . . . 70 °C, and again 20 °C for CO₂ only, with in between a sample evacuation for 1 h at intermediate temperature. The repetition measurement of the CO₂ adsorption isotherm at 20 °C after the measurements at 70 °C (i.e., including a sample evacuation for >1 h at >60 °C to 0.007 bar; ~3.5% of the saturation pressure of H₂O at 60 °C) tested the possible removal of cation-bound water due to the evacuation of the samples at elevated temperatures. These repetition measurements (black squares in FIG. 11a-b) revealed no significant change (possibly a small reduction for Ca-bentonite only) in CO₂ adsorption capacity, indicating the ability of both materials to retain cation-bound water even under these conditions.

Similar to Cs- and TMA-bentonite (and contrary to Na-bentonite), the CO₂ adsorption isotherms of Mg- and Ca-bentonite are negatively curved in the low-pressure domain and increase more gradually in the high-pressure (>3 bar) domain and their steepness in the low-pressure domain and their high pressure capacity decrease with increasing temperature. Their maximum CO₂ adsorption capacities (at 10 °C and 10 bar) is ~1.17 mmol g⁻¹ and ~1.13 mmol g⁻¹, respectively, while for Na-, Cs-, and TMA-bentonite this is ~0.23 mmol g⁻¹, ~1.25 mmol g⁻¹, and ~1.16 mmol g⁻¹, respectively. Qualitatively similar to Na- and Cs-bentonite (and contrary to TMA-bentonite), the CH₄ adsorption isotherms of Mg- and Ca-bentonite are only weakly curved with a maximum CH₄ adsorption (at 10 °C and 10 bar) of ~0.26 mmol g⁻¹ and ~0.17 mmol g⁻¹, respectively, which smaller than their respective CO₂ adsorption capacities. This maximum CH₄ adsorption is, however, somewhat larger than on Na-bentonite (~0.08 mmol g⁻¹) and for Mg-bentonite also somewhat larger than on Cs-bentonite (~0.18 mmol g⁻¹) yet smaller than on TMA-bentonite (~0.76 mmol g⁻¹).

The adsorption isotherms were fit with the (multi-site) Langmuir adsorption isotherm (as described in Example 1). The CO₂/CH₄ adsorption selectivity S can then be defined by the ratio of adsorption capacities at given temperature and pressure (see FIG. 11a-b; thus not taking into account competitive or synergistic effects), as presented in FIG. 11c-d. For both materials, the selectivity decreases with increasing pressure and temperature mainly due to the CO₂ adsorption isotherms that saturate at high pressure and show a reduced curvature at higher temperatures. These trends are in line with those reported for Cs-bentonite and MMA-bentonite. The selectivities at near-ambient conditions, i.e., T=20 °C and P_{CO2}═P_{CH4}=0.5 bar, are S≈23 and S≈19 for Mg-bentonite and Ca-bentonite, respectively; somewhat smaller than the selectivity of Cs-bentonite (S=35) and approximately equal to the selectivity of MMA-bentonite (S≈23) under equivalent conditions.

### Fixed-Bed Adsorption and Regeneration

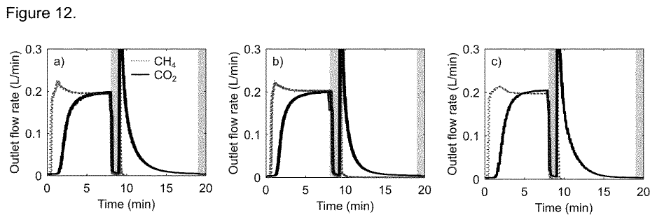

To study the applicability of these sorbents in cyclic gas separation measurements, 11 (Mg-bentonite; FIG. 12a), 14 (Ca-bentonite; FIGS. 12b) and 6 (Cs-bentonite; FIG. 12c) consecutive adsorption-desorption cycles using the fixed-bed setup loaded with 40 g of the bentonite particles were measured. Each cycle comprised (i) an adsorption step with a duration of 8 minutes and an inflow rate of 0.40 L min⁻¹ with an equimolar mixture comprising only CO₂ and CH₄, (ii) an idle (i.e., no inflow) step with a duration of 1 minute, (iii) a desorption step with a duration of 10 minutes and an inflow rate of 0.60 L min with pure N₂, and (iv) another idle step with a duration of 1 minute. FIG. 12 displays the flow rates of CO₂ and CH₄ at the outlet of the column as a function of time and for the cycles shifted on top of each other. The integration of the CO₂ and CH₄ outflow rates over time (and a comparison with the total inflow) furthermore allows to calculate the amount CH₄ and CO₂ adsorbed during the adsorption step and desorbed during the desorption step. These are tabulated in Table 2 together with the adsorption based on the single component isotherms under reactor conditions. The goal of these experiments is threefold; to test (i) the ability of the particles to adsorb, retain, and thereby separate CO₂ on the relevant time scale from the mixture of CO₂ and CH₄, (ii) the regeneration time (under N₂ purge) after the particles have been saturated with CO₂ and CH₄, and (iii) the cyclic stability of the sorbent particles.

TABLE 2
Adsorption capacity based on the single component isotherms (in mmol
g⁻¹, error is estimated), and as measured in the fixed bed reactor during
adsorption and desorption (in mmol g⁻¹ and are averaged over all
cycles where the reported error is one standard deviation).

| | Single component | | Adsorption | | Desorption | |
|---|---|---|---|---|---|---|
| Material | q_{CO}_{₂}^{a} | q_{CH}_{₄}^{a} | q_{CO}_{₂}^{b} | q_{CH}_{₄}^{b} | q_{CO}_{₂}^{b} | q_{CH}_{₄}^{b} |
| Mg- | 0.46 ± | 0.02 ± | 0.47 ± | 0.05 ± | 0.47 ± | −0.03 ± |
| bentonite | 0.01 | 0.01 | 0.02 | 0.02 | 0.03 | 0.04 |
| Ca- | 0.36 ± | 0.02 ± | 0.33 ± | −0.02 ± | 0.38 ± | 0.01 ± |
| bentonite | 0.01 | 0.01 | 0.01 | 0.01 | 0.03 | 0.05 |
| Cs- | 0.45 ± | 0.01 ± | 0.42 ± | 0.03 ± | 0.48 ± | −0.02 ± |
| bentonite | 0.01 | 0.01 | 0.01 | 0.01 | 0.03 | 0.05 |

^{a}At 0.5 bar, 20 °C, from the isotherms in FIG. 11 and Example 1 (Cs-bentonite) and corrected for the binder material.
^{b}Gas volume in the void space is subtracted (assuming V_{void} = 65 mL with c_{CO2}═c_{CH4} = 0.5).

Regarding (i) and for all bentonites, after the mixture of CO₂ and CH₄ is switched to the inlet of the column and the N₂ initially present in the column voids is displaced, first the signal of CH₄ grows rapidly while no CO₂ is detected. This implies that the now purified CH₄ leaves the column, while the CO₂ is retained. Once the CO₂ adsorption in the bed approaches saturation, the CO₂ is also detected in the effluent. The breakthrough times for CH₄ and CO₂ are tabulated in Table 3, together with the similar results from Example 1 on Cs- and TMA-bentonite for comparison. The breakthrough time for CH₄ is nearly identical for all bentonites except TMA-bentonite (which has a larger CH₄ adsorption capacity, and thus longer breakthrough time, than the other bentonites; Table 2), and indeed corresponds nearly to the time required to fill the voids in the column (~62-65 mL) with CH₄. The breakthrough time for CO₂ is also nearly identical for all bentonites except Ca-bentonite, which can be attributed to the somewhat smaller CO₂ adsorption capacity of this material (FIG. 11 and Table 2). The breakthrough measurements furthermore illustrate that the Mg- and Ca-bentonite particles that were prepared in a different manner than the Cs-bentonite particles (i.e., with a rubber instead of Na-bentonite binder material) are also sufficiently porous to allow for the fast diffusional transport of species within the particle, in agreement with the kinetic measurements and in contrast to MMA-bentonite particles.

TABLE 3
CH₄ and CO₂ breakthrough times and experimental
conditions for the different bentonite particles.

| Material | Mass | T | | CH₄ | CO₂ | |
|---|---|---|---|---|---|---|
| Mg-bent. | 40 g | 19 | °C | 20 s | 82 | s |
| Ca-bent. | 40 g | 20 | °C | 15 s | 61 | s |
| Cs-bent. | 40 g | 18 | °C | 21 s | 80 | s |
| Cs-bent. (Example 1) | 50 g | ~23 | °C^{a} | 19 s | ~1.3 | min^{b} |
| TMA-bent. (Example 1) | 50 g | ~23 | °C^{a} | 41 s | ~1.3 | min^{b} |

^{a}Average ambient temperature and
^{b}average breakthrough time for a multitude of experiments.

Regarding (ii) and for all bentonites, after 9 minutes (i.e., after the N₂ purge is switched to the inlet of the column), immediately a large flow of CH₄ and CO₂ is detected which can in the first place be attributed to the displacement of the CO₂ and CH₄ in the column void. While the outflow rate of CH₄ drops rapidly to <0.01 L min⁻¹ within around 30 s, the amount of desorbed CO₂ and its typical desorption time scale are clearly larger than for CH₄ (Table 2). Nonetheless, around 95% of the total desorbed CO₂ is desorbed in the first 6 minutes of the desorption step, and only around 5% is desorbed in the final 4 minutes of the desorption step. Similar to Cs- and TMA-bentonite (Example 1) and important for their application, also the Mg- and Ca-bentonite thus regenerate quickly without the input of heat (i.e., within several minutes; in agreement with the reported desorption time of CO₂ from smectites with a similar initial d-spacing upon exposure to vacuum or air.

Regarding (i) and (ii) and as tabulated in Table 2, it is noted that the adsorption and the desorption in the column agree reasonably well with the expected adsorption based on the single component isotherms (i.e., their error margins nearly overlap). Competitive and synergistic effects with respect to the adsorption of CO₂ and CH₄ thus appear to be insignificant here, similar to the Cs-bentonite and contrary to the TMA-bentonite (where the co-adsorption of CO₂ reduced the adsorption of CH₄).

Regarding (iii), it is conceivable that the cyclic (CO₂) adsorption capacity (and thereby the breakthrough time) of the materials can be reduced by either the removal of cation-bound H₂O resulting in the collapse of the interlayer space (specifically for the Mg- and Ca-bentonites; see FIG. 10), or by the formation of (quasi-) irreversibly adsorbed species (e.g., metal carbonates) in the interlayer space that effectively occupy the initially available adsorption volume. Given that the outflow rates for all cycles nearly overlap, both failure mechanisms do not manifest within the duration of these experiments. Indeed, the total duration of the experiment for Mg- and Ca-bentonite was ~3-4 hrs, corresponding to 2.5-3.2 L dry gas purge per gram of sorbent particles; much shorter and involving much less dry gas then required for the collapse of Ca-bentonite, let alone Mg-bentonite (FIG. 10b).

While metal carbonation seems unlikely for this system, a collapse of the interlayer space due to the removal of cation-bound H₂O may occur during (much) longer dry gas feed times, is likely accelerated under high vacuum and/or elevated temperature conditions, and thus requires a durability test under operating conditions. In practice, however, the residual humidity in the inlet biogas stream seems to stabilize the sorbent (FIG. 10a), and should it nevertheless collapse, it can simply be re-activated under humid conditions (FIG. 8).

This work demonstrates that essentially natural, readily available bentonites (natural bentonite exchanged with the readily available and cheap Mg²⁺ and Ca²⁺ cations, or potentially natural Ca-rich bentonites) can be applied for biogas upgrading using a (vacuum-) pressure swing.

### Example 3

Example 3 shows the CO₂ adsorption capacities of montmorillonite (MMT, SWy-2/3) or bentonite (bent) clays exchanged with different cations. CO₂ adsorption was measured at 20 °C (or room temperature) and 1 bar CO₂.

Poor CO₂ adsorption capacities were found for clays exchanged with Li, Na, Ba, K, NH₄, tetraethylammonium (TEA), non-hydrated Ca or non-hydrated Mg. High CO₂ adsorption capacities were found for clays exchanged with Cs, monomethylammonium (MMA), tetramethylammonium (TMA), hydrated Ca or hydrated Mg (Table 4).

TABLE 4
CO₂ adsorption capacities of montmorillonite (MMT, Swy-2/3)
or bentonite (bent) clays exchanged with different cations.

| | | CO₂ adsorption | |
|---|---|---|---|
| Cation | Clay | (mmol/g) | Drying condition |
| Li | MMT | 0.07 | 150 °C |
| Ca | MMT | 0.11 | 150 °C |
| Na | MMT | 0.02 | 150 °C |
| Ba | MMT | 0.20 | 150 °C |
| K | MMT | 0.19 | 150 °C |
| NH₄ | MMT | 0.20 | 150 °C |
| Cs | MMT | 0.93 | 150 °C |
| TMA | MMT | 0.78 | 150 °C |
| TEA | MMT | 0.00 | 150 °C |
| Mg | MMT | 0.40 | 150 °C |
| Mg | MMT | 0.02 | 300 °C |
| Na | bent | 0.05 | 150 °C |
| Cs | bent | 0.63 | 150 °C |
| MMA | bent | 0.45 | 150 °C |
| TMA | bent | 0.61 | 150 °C |
| Mg | bent | 0.62 | N₂ |
| Ca | bent | 0.53 | N₂ |
| Mg | bent | 0.36 | 150 °C |
| Ca | bent | 0.11 | 150 °C |
| Mg | bent | 0.16 | 200 °C |
| Ca | bent | 0.14 | 200 °C |

1.-36. (canceled)

37. A method for obtaining a CH₄-enriched gas fraction from a gas mixture comprising CO₂ and CH₄, the method comprising contacting the gas mixture with an adsorbent and obtaining a CH₄-enriched gas fraction,
wherein the adsorbent comprises an aluminum phyllosilicate material with one or more intercalating moieties selected from the group consisting of Cs⁺ cation, hydrated Mg²⁺ cation, a C₁-C₄ alkyl ammonium cation and optionally hydrated Ca²⁺ cation to thereby provide a basal spacing in the range of 10-15 Å.

38. The method according to claim 37, wherein the C₁-C₄ alkyl ammonium cation is methylammonium cation and/or tetramethylammonium cation.

39. The method according to claim 37, wherein CO₂ from the gas mixture is adsorbed on the adsorbent.

40. The method according to claim 37, wherein the aluminum phyllosilicate is a smectite- and/or vermiculite-containing material.

41. The method according to claim 40, wherein the smectite-containing material comprises one or more selected from the group consisting of montmorillonite, beidellite, nontronite, volkonskoite, hectorite, saponite, and sauconite.

42. The method according to claim 37, wherein the amount of the one or more of intercalating moieties in the aluminum phyllosilicate material is 0.1-3 mEq per g aluminum phyllosilicate material.

43. The method according to claim 37, wherein the adsorbent comprises 1-40 wt. % of a binder material and 60-99 wt. % of the aluminum phyllosilicate material, calculated on weight of the binder material and the aluminum phyllosilicate material.

44. The method according to claim 43, wherein the binder material is a non-activated aluminum phyllosilicate material and/or a plasticizing organic binder.

45. The method according to claim 37, wherein the adsorbent is provided in one or more forms selected from the group consisting of a powder, a film, a fiber, a coating, a self-supported structure, a monolith and particles.

46. The method according to claim 45, wherein the particles have an average diameter of 0.1-50 mm.

47. The method according to claim 37, wherein the gas mixture is contacted with the adsorbent at a CO₂ partial pressure of 0.1-10 bar or wherein the gas mixture is contacted with the adsorbent at a temperature 0-70 °C.

48. The method according to claim 37, wherein the gas mixture comprises 30-60 vol. % CO₂ and 40-70 vol. % CH₄, calculated on the gas mixture.

49. The method according to claim 37, wherein the CH₄-enriched gas fraction comprises 1-30 vol. % CO₂ and 70-95 vol. % CH₄, calculated on the CH₄-enriched gas fraction.

50. The method according to claim 37, wherein method is performed at least partially in a fixed-bed reactor.

51. A method comprising:
utilizing an aluminum phyllosilicate material or adsorbent for obtaining a CH₄-enriched gas fraction from a gas mixture comprising CO₂ and CH₄,
wherein the aluminum phyllosilicate material and the adsorbent are as defined in claim 37.

52. A device for obtaining a CH₄-enriched gas fraction from a gas mixture comprising CO₂ and CH₄, the device comprising the aluminum phyllosilicate material and/or the absorbent as defined in any one of the preceding claims.

53. The device according to claim 52, wherein the device is a fixed-bed reactor.

54. An aluminum phyllosilicate material for obtaining a CH₄-enriched gas fraction from a gas mixture comprising CO₂ and CH₄,
wherein the aluminum phyllosilicate material has one or more intercalating moieties selected from the group consisting of Cs⁺ cation, hydrated Mg²⁺ cation and a C₁-C₄ alkyl ammonium cation, to thereby provide a basal spacing in the range of 10-15 Å,
wherein the aluminum phyllosilicate material has a selectivity in CO₂/CH₄ adsorption of at least 2, wherein selectivity in CO₂/CH₄ adsorption is defined as the ratio in CO₂/CH₄ adsorption capacity measured at a total pressure of 1 bar and at 20 °C for a 50/50 vol. % CO₂/CH₄ gas mixture.

55. The aluminum phyllosilicate material according to claim 54, wherein the C₁-C₄ alkyl ammonium cation is methylammonium cation and/or tetramethylammonium cation, or wherein the aluminum phyllosilicate material has a CO₂ adsorption capacity of at least 0.8 mmol g⁻¹, measured at a pressure of 10 bar and at 20 °C for pure CO₂, or wherein the aluminum phyllosilicate material is a smectite- and/or vermiculite-containing material,
or wherein the amount of the one or more of intercalating moieties in the aluminum phyllosilicate material is 0.1-3 mEq per g aluminum phyllosilicate material.

56. An adsorbent for obtaining a CH₄-enriched gas fraction from a gas mixture comprising CO₂ and CH₄, the adsorbent comprising 1-40 wt. % of a binder material and 60-99 wt. % of the aluminum phyllosilicate material as defined in claim 54.
